(19) United States
(12) Patent Application Publication
(10) Pub. No.: US 2026/0184510 A1
(43) Pub. Date: Jul. 2, 2026

(54) METHODS AND APPARATUS FOR PALLET HANDLING

(71) Applicant: Boston Dynamics, Inc., Waltham, MA (US)

(72) Inventors: Michael P. Murphy, Carlisle, MA (US); Oliver Lewis, Waltham, MA (US); Krista Shapton, Malden, MA (US); Christopher Bentzel, Quincy, MA (US); Engin Hassamanci, Belmont, MA (US); Frank Croghan, Millbury, MA (US)

(21) Appl. No.: 19/001,872

(22) Filed: Dec. 26, 2024

(51) Int. Cl. B65G 1/137

(52) U.S. Cl. CPC B65G 1/1373; B65G 2201/0267; B65G 2203/041

(57) ABSTRACT

Method and apparatus for grasping an empty pallet using a mobile robotic device are provided. Sensor data captured by at least one sensor is used to identify an empty pallet. Based on at least one characteristic of the empty pallet and at least one capability of a mobile robotic device, it is determined whether to grasp the empty pallet using an end effector of the mobile robotic device. The empty pallet is grasped using the end effector of the robotic device. In response to determining, based on image capture data corresponding to an initial position in which the empty pallet is placed on a cart coupled to the mobile robotic device, that the initial position is different from a target position, the empty pallet is moved from the initial position to the target position using the end effector.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

For logistic workflows in warehouse environments, decoupling of robotic operations (e.g., palletizing/order building, cleaning/organization, etc.) from operations otherwise requiring synchronization with (e.g., intervention by and/or assistance from) humans is desirable. Typically, for robotic operations involving interactions with empty pallets, a human is required for selecting and providing an empty pallet to the robot. The inventors have recognized and appreciated that configuring the robot to autonomously manipulate (e.g., grasp and/or load) empty pallets may be desirable to reduce the reliance on humans to perform this function. To this end, some embodiments of the present disclosure relate to a mobile robot configured to manipulate an empty pallet. In some embodiments, manipulation of an empty pallet may include one or more of identifying an empty pallet, grasping (e.g., using an end effector of the robot) an empty pallet, placing an empty pallet at a location, or aligning an empty pallet onto a portion of the robot or an accessory (e.g., a cart) coupled to and/or located near the robot.

In some embodiments, the invention features a method. The method includes identifying, using sensor data captured by at least one first sensor, an empty pallet, determining whether to grasp the empty pallet using an end effector of a mobile robotic device based on at least one characteristic of the empty pallet and at least one capability of the mobile robotic device, and grasping the empty pallet using the end effector of the mobile robotic device.

In one aspect, the at least one first sensor includes a sensor coupled to the mobile robotic device. In another aspect, the at least one first sensor includes a sensor external to the mobile robotic device, where the sensor is located in an environment of the mobile robotic device. In another aspect, the at least one first sensor includes at least one of a two-dimensional (2D) camera or a stereoscopic camera. In another aspect, the 2D camera comprises a red-green-blue (RGB) monocular camera. In another aspect, identifying the empty pallet comprises determining the at least one characteristic of the empty pallet based on the sensor data and identifying the empty pallet based on the at least one characteristic. In another aspect, identifying the empty pallet comprises detecting, in the sensor data, an identifier tag identifying the empty pallet. In another aspect, identifying the empty pallet comprises determining the sensor data indicates the mobile robotic device is positioned at a location known to include empty pallets. In another aspect, determining whether to grasp the empty pallet using the end effector comprises determining a location to place the empty pallet once grasped and determining whether to grasp the empty pallet using the end effector based on the location to place the empty pallet.

In another aspect, grasping the empty pallet using the end effector comprises determining a target location to place the empty pallet using the end effector, based on the target location, determining to grasp the empty pallet at a first grasping location on the empty pallet, and grasping the empty pallet at the first grasping location. In another aspect, determining whether to grasp the empty pallet using the end effector based on the at least one characteristic of the empty pallet comprises determining a condition of the empty pallet based on the sensor data and determining whether to grasp the empty pallet based on the condition of the empty pallet. In another aspect, grasping the empty pallet using the end effector comprises determining a condition of the empty pallet based on the sensor data, based on the condition, determining to grasp the empty pallet at a first grasping location on the empty pallet, and grasping the empty pallet at the first grasping location. In another aspect, determining whether to grasp the empty pallet using the end effector based on the at least one characteristic of the empty pallet comprises determining a size of the empty pallet based on the sensor data and determining whether to grasp the empty pallet based on the size of the empty pallet. In another aspect, grasping the empty pallet using the end effector comprises determining a size of the empty pallet based on the sensor data, based on the size, determining to grasp the empty pallet at a first grasping location on the empty pallet, and grasping the empty pallet at the first grasping location. In another aspect, determining whether to grasp the empty pallet using the end effector based on the at least one characteristic of the empty pallet comprises determining a pallet type of the empty pallet based on the sensor data and determining whether to grasp the empty pallet based on the pallet type of the empty pallet.

In another aspect, grasping the empty pallet using the end effector comprises determining a pallet type of the empty pallet based on the sensor data, based on the pallet type, determining to grasp the empty pallet at a first grasping location on the empty pallet, and grasping the empty pallet at the first grasping location. In another aspect, determining whether to grasp the empty pallet using the end effector based on the at least one capability of the mobile robotic device comprises determining whether the end effector is configured for grasping empty pallets and determining whether to grasp the empty pallet using the end effector based on determining the end effector is configured for grasping empty pallets. In another aspect, determining whether to grasp the empty pallet using the end effector based on the at least one characteristic of the empty pallet and the at least one capability of the mobile robotic device comprises estimating a size of the empty pallet using the sensor data, determining whether the end effector is configured for grasping empty pallets of the size, and determining whether to grasp the empty pallet using the end effector based on determining the end effector is configured for grasping empty pallets of the estimated size. In another aspect, determining whether to grasp the empty pallet using the end effector based on the at least one characteristic of the empty pallet and the at least one capability of the mobile robotic device comprises estimating a weight of the empty pallet based on the sensor data, determining whether the end effector is configured for grasping empty pallets having the estimated weight, and determining whether to grasp the empty pallet using the end effector based on determining the end effector is configured for grasping empty pallets having the estimated weight.

In another aspect, the end effector comprises a robotic gripper coupled to a robotic arm of the mobile robotic device, the robotic gripper including a plurality of vacuum assemblies, and grasping the empty pallet using the end effector of the mobile robotic device comprises activating at least some of the plurality of vacuum assemblies to grasp the empty pallet. In another aspect, the end effector comprises a mechanical accessory coupled to a robotic arm of the mobile robotic device, and grasping the empty pallet comprises grasping the empty pallet using the mechanical accessory. In another aspect, the method further comprises moving a mobile base of the mobile robotic device to a position to grasp the empty pallet

In some embodiments, the invention features a method including controlling an end effector of a mobile robotic device to place an empty pallet on a cart coupled to the mobile robotic device, receiving image capture data corresponding to an initial position in which the empty pallet is placed on the cart, determining, based on the image capture data, that the initial position is different from a target position, and in response to determining the initial position is different from the target position, moving the empty pallet from the initial position to the target position using the end effector.

In one aspect, moving the empty pallet into the target position comprises pushing the empty pallet from the initial position into the target position using the end effector. In another aspect, moving the empty pallet into the target position comprises pulling the empty pallet from the initial position into the target position using the end effector. In another aspect, the end effector includes a plurality of vacuum assemblies, and controlling the end effector to place the empty pallet on the cart comprises activating the plurality of vacuum assemblies to grasp the empty pallet, positioning the empty pallet on the cart coupled to the mobile robotic device, and deactivating the plurality of vacuum assemblies to release the empty pallet. In another aspect, the end effector comprises a mechanical accessory coupled to a robotic arm of the mobile robotic device, and controlling the end effector to place the empty pallet on the cart comprises grasping the empty pallet using the mechanical accessory of the end effector and placing the empty pallet on the cart.

In another aspect, the cart is detachably coupled to the mobile robotic device. In another aspect, the cart is fixedly coupled to the mobile robotic device. In another aspect, the method further comprises, after moving the empty pallet from the initial position into the target position, placing one or more objects on the empty pallet, moving a mobile base of the mobile robotic device to a target destination, and offloading the empty pallet including the one or more objects to the target destination.

In some embodiments, the invention features a mobile robotic device. The mobile robotic device includes a mobile base, an end effector, and a controller configured to identify an empty pallet using sensor data received from at least one first sensor, determine whether to grasp the empty pallet using the end effector based on at least one characteristic of the empty pallet and at least one capability of the mobile robotic device, and control the end effector to grasp the empty pallet.

In one aspect, the mobile robotic device further comprises the at least one first sensor. In another aspect, the at least one first sensor includes a sensor located in an environment of the mobile robotic device. In another aspect, the at least one first sensor includes at least one of a two-dimensional (2D) camera or a stereoscopic camera. In another aspect, the 2D camera comprises a red-green-blue (RGB) monocular camera. In another aspect, identifying the empty pallet comprises determining the at least one characteristic of the empty pallet based on the sensor data and identifying the empty pallet based on the at least one characteristic. In another aspect, identifying the empty pallet comprises detecting, in the sensor data, an identifier tag identifying the empty pallet. In another aspect, identifying the empty pallet comprises determining the sensor data indicates the mobile robotic device is positioned at a location known to include empty pallets.

In another aspect, determining whether to grasp the empty pallet using the end effector comprises determining a location to place the empty pallet once grasped and determining whether to grasp the empty pallet using the end effector based on the location to place the empty pallet. In another aspect, grasping the empty pallet using the end effector comprises determining a target location to place the empty pallet using the end effector, based on the target location, determining to grasp the empty pallet at a first grasping location on the empty pallet, and controlling the end effector to grasp the empty pallet at the first grasping location. In another aspect, determining whether to grasp the empty pallet using the end effector based on the at least one characteristic of the empty pallet comprises determining a condition of the empty pallet based on the sensor data and determining whether to grasp the empty pallet based on the condition of the empty pallet. In another aspect, controlling the end effector to grasp the empty pallet comprises determining a condition of the empty pallet based on the sensor data, based on the condition, determining to grasp the empty pallet at a first grasping location on the empty pallet, and controlling the end effector to grasp the empty pallet at the first grasping location. In another aspect, determining whether to grasp the empty pallet using the end effector based on the at least one characteristic of the empty pallet comprises determining a size of the empty pallet based on the sensor data and determining whether to grasp the empty pallet based on the size of the empty pallet.

In another aspect, controlling the end effector to grasp the empty pallet comprises determining a size of the empty pallet based on the sensor data, based on the size, determining to grasp the empty pallet at a first grasping location on the empty pallet, and controlling the end effector to grasp the empty pallet at the first grasping location. In another aspect, determining whether to grasp the empty pallet using the end effector based on the at least one characteristic of the empty pallet comprises determining a pallet type of the empty pallet based on the sensor data and determining whether to grasp the empty pallet based on the pallet type of the empty pallet. In another aspect, controlling the end effector to grasp the empty pallet comprises determining a pallet type of the empty pallet based on the sensor data, based on the pallet type, determining to grasp the empty pallet at a first grasping location on the empty pallet, and controlling the end effector to grasp the empty pallet at the first grasping location.

In another aspect, determining whether to grasp the empty pallet using the end effector based on the at least one capability of the mobile robotic device comprises determining whether the end effector is configured for grasping empty pallets and determining whether to grasp the empty pallet using the end effector based on determining the end effector is configured for grasping empty pallets. In another aspect, determining whether to grasp the empty pallet using the end effector based on the at least one characteristic of the empty pallet and the at least one capability of the mobile robotic device comprises estimating a size of the empty pallet using the sensor data, determining whether the end effector is configured for grasping empty pallets of the size, and determining whether to grasp the empty pallet using the end effector based on determining the end effector is configured for grasping empty pallets of the estimated size. In another aspect, determining whether to grasp the empty pallet using the end effector based on the at least one characteristic of the empty pallet and the at least one capability of the mobile robotic device comprises estimating a weight of the empty pallet based on the sensor data, determining whether the end effector is configured for grasping empty pallets having the estimated weight, and determining to whether grasp the empty pallet using the end effector based on determining the end effector is configured for grasping empty pallets having the estimated weight.

In another aspect, the mobile robotic device may further comprise a robotic arm, where the end effector comprises a robotic gripper coupled to the robotic arm, the robotic gripper including a plurality of vacuum assemblies, and controlling the end effector to grasp the empty pallet comprises activating at least some of the plurality of vacuum assemblies to grasp the empty pallet. In another aspect, the mobile robotic device may further comprise a robotic arm, where the end effector comprises a mechanical accessory coupled to the robotic arm, and controlling the end effector to grasp the empty pallet comprises controlling the end effector to grasp the empty pallet using the mechanical accessory. In another aspect, the controller is further configured to control the mobile base to move to a position to grasp the empty pallet.

In some embodiments, the invention features a controller for a mobile robotic device. The controller is configured to identify an empty pallet using sensor data received from at least one first sensor, determine whether to grasp the empty pallet using an end effector of the mobile robotic device based on at least one characteristic of the empty pallet and at least one capability of the mobile robotic device, and control the end effector to grasp the empty pallet.

In one aspect, the at least one first sensor includes a sensor coupled to the mobile robotic device. In another aspect, the at least one first sensor includes a sensor external to the mobile robotic device, the sensor located in an environment of the mobile robotic device. In another aspect, the at least one first sensor includes at least one of a two-dimensional (2D) camera or a stereoscopic camera. In another aspect, the 2D camera comprises a red-green-blue (RGB) monocular camera. In another aspect, identifying the empty pallet comprises determining the at least one characteristic of the empty pallet based on the sensor data and identifying the empty pallet based on the at least one characteristic. In another aspect, identifying the empty pallet comprises detecting, in the sensor data, an identifier tag identifying the empty pallet. In another aspect, identifying the empty pallet comprises determining the sensor data indicates the mobile robotic device is positioned at a location known to include empty pallets.

In another aspect, determining whether to grasp the empty pallet using the end effector comprises determining a location to place the empty pallet once grasped and determining whether to grasp the empty pallet using the end effector based on the location to place the empty pallet. In another aspect, controlling the end effector to grasp the empty pallet comprises determining a target location to place the empty pallet using the end effector, based on the target location, determining to grasp the empty pallet at a first grasping location on the empty pallet, and controlling the end effector to grasp the empty pallet at the first grasping location. In another aspect, determining whether to grasp the empty pallet using the end effector based on the at least one characteristic of the empty pallet comprises determining a condition of the empty pallet based on the sensor data and determining whether to grasp the empty pallet based on the condition of the empty pallet.

In another aspect, controlling the end effector to grasp the empty pallet comprises determining a condition of the empty pallet based on the sensor data, based on the condition, determining to grasp the empty pallet at a first grasping location on the empty pallet, and controlling the end effector to grasp the empty pallet at the first grasping location. In another aspect, determining whether to grasp the empty pallet using the end effector based on the at least one characteristic of the empty pallet comprises determining a size of the empty pallet based on the sensor data and determining whether to grasp the empty pallet based on the size of the empty pallet. In another aspect, controlling the end effector to grasp the empty pallet comprises determining a size of the empty pallet based on the sensor data, based on the size, determining to grasp the empty pallet at a first grasping location on the empty pallet, and controlling the end effector to grasp the empty pallet at the first grasping location. In another aspect, determining whether to grasp the empty pallet using the end effector based on the at least one characteristic of the empty pallet comprises determining a pallet type of the empty pallet based on the sensor data and determining whether to grasp the empty pallet based on the pallet type of the empty pallet.

In another aspect, controlling the end effector to grasp the empty pallet comprises determining a pallet type of the empty pallet based on the sensor data, based on the pallet type, determining to grasp the empty pallet at a first grasping location on the empty pallet, and controlling the end effector to grasp the empty pallet at the first grasping location. In another aspect, determining whether to grasp the empty pallet using the end effector based on the at least one capability of the mobile robotic device comprises determining whether the end effector is configured for grasping empty pallets and determining whether to grasp the empty pallet using the end effector based on determining the end effector is configured for grasping empty pallets. In another aspect, determining whether to grasp the empty pallet using the end effector based on the at least one characteristic of the empty pallet and the at least one capability of the mobile robotic device comprises estimating a size of the empty pallet using the sensor data, determining whether the end effector is configured for grasping empty pallets of the size, and determining to grasp the empty pallet using the end effector based on determining the end effector is configured for grasping empty pallets of the estimated size.

In another aspect, determining whether to grasp the empty pallet using the end effector based on the at least one characteristic of the empty pallet and the at least one capability of the mobile robotic device comprises estimating a weight of the empty pallet based on the sensor data, determining whether the end effector is configured for grasping empty pallets having the estimated weight, and determining to grasp the empty pallet using the end effector based on determining the end effector is configured for grasping empty pallets having the estimated weight. In another aspect, the end effector comprises a robotic gripper coupled to a robotic arm of the mobile robotic device, the robotic gripper including a plurality of vacuum assemblies, and controlling the end effector to grasp the empty pallet comprises activating at least some of the plurality of vacuum assemblies to grasp the empty pallet. In another aspect, the end effector comprises a mechanical accessory coupled to a robotic arm of the mobile robotic device, and controlling the end effector to grasp the empty pallet comprises controlling the end effector to grasp the empty pallet using the mechanical accessory. In another aspect, the controller is further configured to control a mobile base of the mobile robotic device to move to a position to grasp the empty pallet.

In some embodiments, the invention features a mobile robotic device. The mobile robotic device comprises at least one sensor, an end effector, a cart coupled to the mobile robotic device, and a controller. The controller is configured to control the end effector of the mobile robotic device to place an empty pallet on the cart, receive image capture data corresponding to an initial position in which the empty pallet is placed on the cart, determine, based on the image capture data, that the initial position is different from a target position, and in response to determining the initial position is different from the target position, control the end effector to move the empty pallet from the initial position to the target position.

In one aspect, controlling the end effector to move the empty pallet into the target position comprises controlling the end effector to push the empty pallet from the initial position into the target position. In another aspect, controlling the end effector to move the empty pallet into the target position comprises controlling the end effector to pull the empty pallet from the initial position into the target position. In another aspect, the end effector includes a plurality of vacuum assemblies, and controlling the end effector to place the empty pallet on the cart comprises activating the plurality of vacuum assemblies to grasp the empty pallet, controlling the end effector to position the empty pallet on the cart coupled to the mobile robotic device, and deactivating the plurality of vacuum assemblies to release the empty pallet. In another aspect, the mobile robotic device further comprises a robotic arm, where the end effector comprises a mechanical accessory coupled to the robotic arm, and controlling the end effector to place the empty pallet on the cart comprises controlling the end effector to grasp the empty pallet using the mechanical accessory and controlling the end effector to place the empty pallet on the cart.

In another aspect, the cart is detachably coupled to the mobile robotic device. In another aspect, the cart is fixedly coupled to the mobile robotic device. In another aspect, the mobile robotic device further comprises a mobile base, where the controller is further configured to, after controlling the end effector to move the empty pallet from the initial position to the target position, control the end effector to place one or more objects on the empty pallet, control the mobile base to move to a target destination, and control the mobile robotic device to offload the empty pallet including the one or more objects to the target destination.

In some embodiments, the invention features a controller for a mobile robotic device. The controller is configured to control an end effector of a mobile robotic device to place an empty pallet on a cart coupled to the mobile robotic device, receive image capture data corresponding to an initial position in which the empty pallet is placed on the cart, determine, based on the image capture data, that the initial position is different from a target position, and in response to determining initial position is different from the target position, control the end effector to move the empty pallet from the initial position to the target position.

In another aspect, controlling the end effector to move the empty pallet into the target position comprises controlling the end effector to push the empty pallet from the initial position into the target position. In another aspect, controlling the end effector to move the empty pallet into the target position comprises controlling the end effector to pull the empty pallet from the initial position into the target position. In another aspect, the end effector includes a plurality of vacuum assemblies, and controlling the end effector to place the empty pallet on the cart comprises activating the plurality of vacuum assemblies to grasp the empty pallet, controlling the end effector to position the empty pallet on the cart, and deactivating the plurality of vacuum assemblies to release the empty pallet. In another aspect, the end effector comprises a mechanical accessory coupled to a robotic arm of the mobile robotic device, and controlling the end effector to place the empty pallet on the cart comprises controlling the end effector to grasp the empty pallet using the mechanical accessory and controlling the end effector to place the empty pallet on the cart.

In another aspect, the cart is detachably coupled to the mobile robotic device. In another aspect, the cart is fixedly coupled to the mobile robotic device. In another aspect, the controller is further configured to, after controlling the end effector to move the empty pallet from the initial position into the target position, control the end effector to place one or more objects on the empty pallet, control a mobile base of the mobile robotic device to move to a target destination, and control the mobile robotic device to offload the empty pallet including the one or more objects to the target destination.

In some embodiments, the invention features a method. The method includes determining a target location to offload a pallet disposed on a portion of a mobile robotic device, controlling the mobile robotic device to navigate from a first location to a second location proximate to the target location, determining that the mobile robotic device is located at the second location, and controlling the mobile robotic device to offload the pallet to the target location when it is determined that the mobile robotic device is located at the second location.

In one aspect, the pallet is disposed on a cart coupled to the mobile robotic device, and controlling the mobile robotic device to offload the pallet to the target location comprises controlling the mobile robotic device to detach the cart from the mobile robotic device at the target location. In another aspect, the pallet is disposed on passive rollers of a cart coupled to the mobile robotic device, and controlling the mobile robotic device to offload the pallet to the target location comprises controlling the mobile robotic device slide the pallet across the passive rollers to the target location. In another aspect, the cart coupled to the mobile robotic device includes a tilting mechanism, and controlling the mobile robotic device to slide the pallet across the passive rollers to the target location comprises activating the tilting mechanism of the cart. In another aspect, the cart includes a stopping mechanism configured to stop the pallet from being offloaded from the cart when the tilting mechanism is activated, and controlling the mobile robotic device to slide the pallet across the passive rollers to the target location further comprises retracting the stopping mechanism to enable the pallet to slide across the passive rollers to the target location. In another aspect, the pallet is disposed on actuated rollers of a cart coupled to the mobile robotic device, and controlling the mobile robotic device to offload the pallet to the target location comprises activating the activating the actuated rollers to offload the pallet from the cart.

In another aspect, the mobile robotic device comprises a robotic arm and a robotic gripper coupled to the robotic arm, and controlling the mobile robotic device to offload the pallet to the target location comprises controlling the robotic arm and/or the robotic gripper to push the pallet from the mobile robotic device to the target location. In another aspect, the mobile robotic device comprises a set of fork tines, the pallet is disposed on the set of fork tines, and controlling the robotic arm and/or the robotic gripper to push the pallet from the mobile robotic device to the target location comprises controlling the robotic arm and/or the robot gripper to push the pallet off the fork tines to the target location. In another aspect, the mobile robotic device comprises a set of fork tines,
the pallet is disposed on the set of fork tines, and controlling the mobile robotic device to offload the pallet from the mobile robotic device to the target location comprises controlling the mobile robotic device to lower the set of fork tines to place the pallet on a surface at the target location, and drive the mobile robotic device away from the pallet once placed on the surface. In another aspect, the target location includes a pallet acceptance device, and controlling the mobile robotic device to offload the pallet from the mobile robotic device to the target location comprises transferring the pallet to the pallet acceptance device. In another aspect, transferring the pallet to the pallet acceptance device comprises driving the mobile robotic device toward the pallet acceptance device such that the pallet acceptance device accepts the pallet. In another aspect, the pallet acceptance device includes a set of fork tines, and transferring the pallet to the pallet acceptance device comprises driving the mobile robotic device towards the set of fork tines such that the set of fork tines are arranged in slots in the pallet, and driving the mobile robotic device away from the set of fork tines after the set of fork tines are arranged in slots of the pallet.

In another aspect, determining that the mobile robotic device is located at the second location comprises scanning an identifier tag located at the second location. In another aspect, determining that the mobile robotic device is located at the second location comprises using sensor data to determine that the mobile robotic device is located at the second location. In another aspect, using sensor data to determine that the mobile robotic device is located at the second location comprises using global positioning system (GPS) data to determine that the mobile robotic device is located at the second location. In another aspect, controlling the mobile robotic device to navigate from the first location to the second location comprises driving the mobile robotic device across a surface from the first location to the second location. In another aspect, the target location comprises a floor of a warehouse. In another aspect, the target location comprises a location raised from a floor of a warehouse. In another aspect, the target location comprises a shelf, a cart, a conveyor, or a truck. In another aspect, the target location corresponds to a location of another mobile robotic device.

In another aspect, the method further includes controlling a robotic gripper of the mobile robotic device to place an object on the pallet to produce a loaded pallet, and determining a target location to offload a pallet comprises determining a target location to offload the loaded pallet. In another aspect, the object comprises another pallet. In another aspect, the pallet comprises an empty pallet.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a perspective view of a robot, according to an illustrative embodiment of the invention.

FIG. 4 is a flowchart of a process for manipulating an empty pallet, according to an illustrative embodiment of the invention.

FIG. 5 is a flowchart of a process for grasping an empty pallet, according to an illustrative embodiment of the invention.

FIG. 6 depicts a robot grasping an empty pallet, according to an illustrative embodiment of the invention.

FIG. 7 depicts a robot coupled to a cart accessory, according to an illustrative embodiment of the invention.

FIG. 8 is a flowchart of a process for adjusting a position of an empty pallet, according to an illustrative embodiment of the invention.

FIG. 9 depicts a robot grasping an empty pallet using a set of tines, according to an illustrative embodiment of the invention.

FIG. 10 depicts a robot manipulating an empty pallet grasped using a set of tines, according to an illustrative embodiment of the invention.

FIG. 11 depicts a robot loading objects onto a pallet, according to an illustrative embodiment of the invention.

FIG. 12 depicts a robot offloading a pallet to a target destination using a cart accessory, according to an illustrative embodiment of the invention.

FIG. 13 depicts a robot offloading a pallet to a target destination using a set of tines, according to an illustrative embodiment of the invention.

FIG. 14 illustrates an example configuration of a robotic device, according to an illustrative embodiment of the invention.

### DETAILED DESCRIPTION

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks).

An example of such a task is interacting with pallets on which objects (e.g., boxes) may be placed. In particular, an empty pallet may be needed prior to placing objects on the pallet and/or an empty pallet may be created after objects on the pallet are removed from the pallet. The task of placing empty pallets in a workspace of a mobile robot and/or removing empty pallets from the workspace of the mobile robot is often performed by a human (e.g., via manual handling, operating a forklift or other machinery, etc.). To reduce reliance on human intervention during logistics workflows, some embodiments of the present disclosure include a robot configured to autonomously grasp and/or load an empty pallet using an end effector of the robot.

To date, both specialist and generalist warehouse robots have been associated with significant limitations. For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

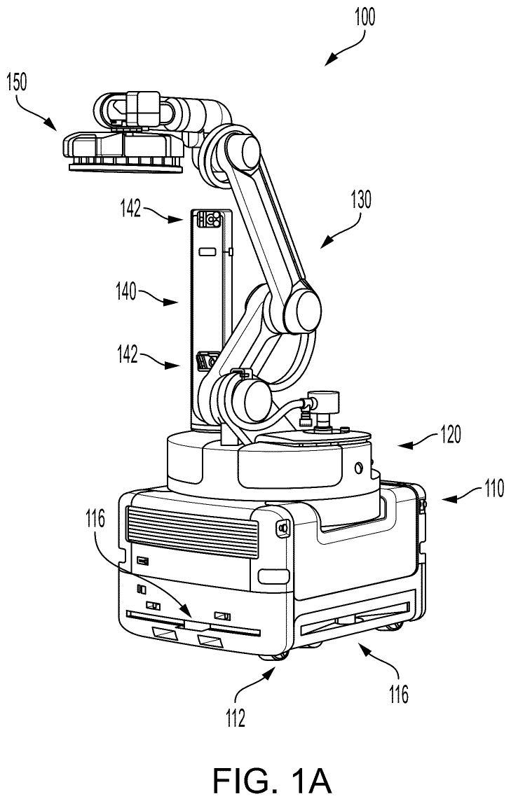

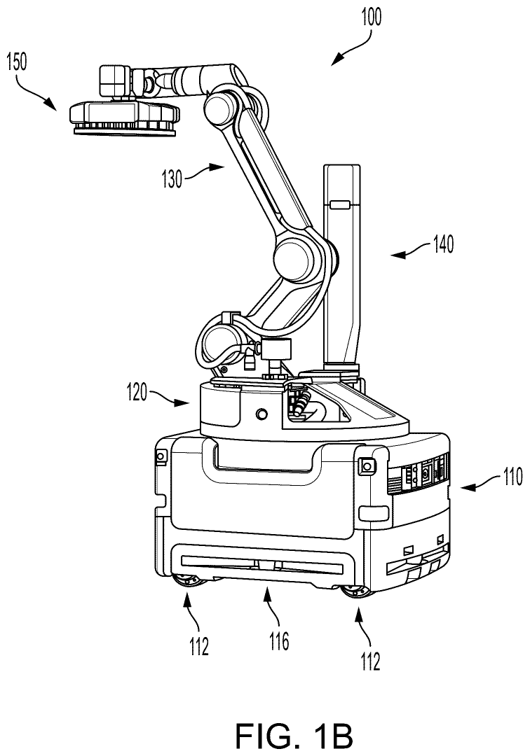

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

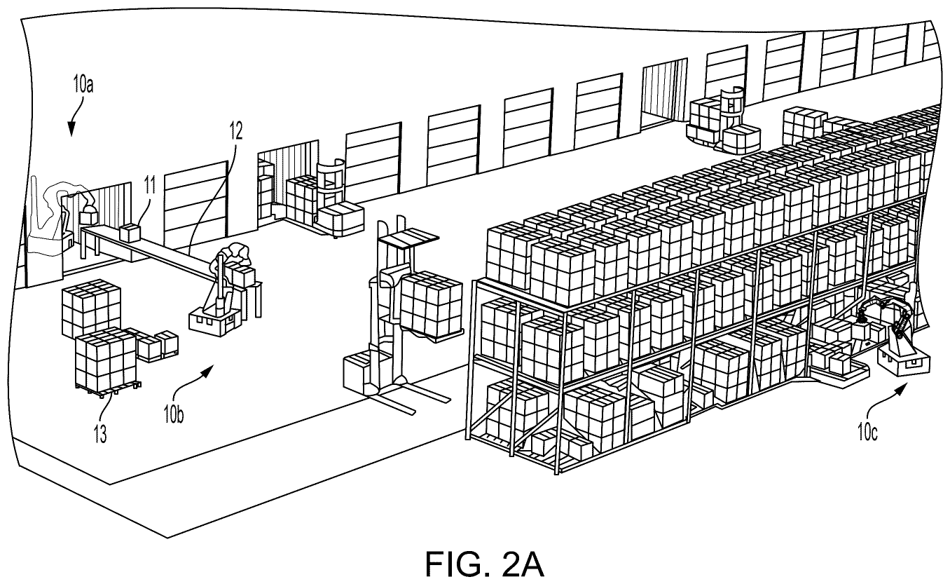

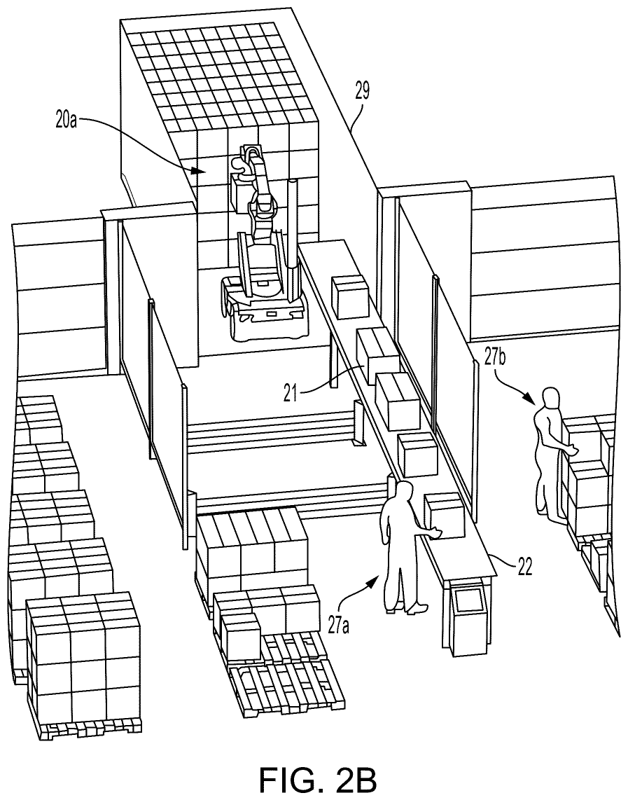

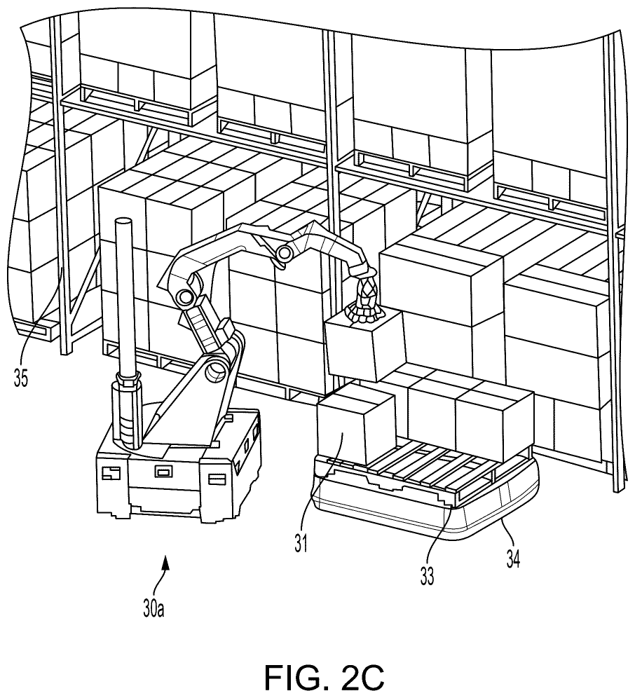

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

### Example Robotic Arm

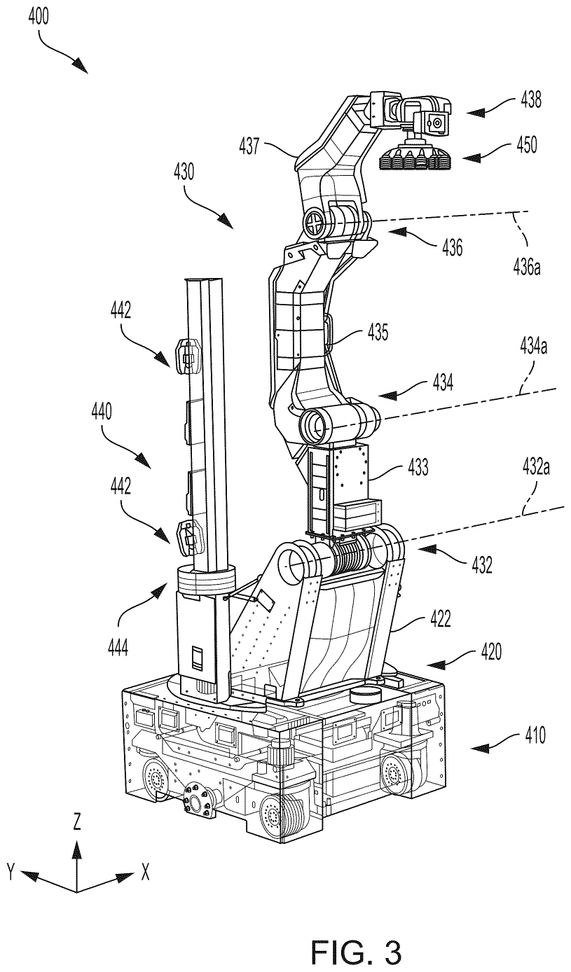

FIG. 3 is a perspective view of a robot 400, according to an illustrative embodiment of the invention. The robot 400 includes a mobile base 410 and a turntable 420 rotatably coupled to the mobile base. A robotic arm 430 is operatively coupled to the turntable 420, as is a perception mast 440. The perception mast 440 includes an actuator 444 configured to enable rotation of the perception mast 440 relative to the turntable 420 and/or the mobile base 410, so that a direction of the perception modules 442 of the perception mast may be independently controlled.

The robotic arm 430 of FIG. 3 is a 6-DOF robotic arm. When considered in conjunction with the turntable 420 (which is configured to yaw relative to the mobile base about a vertical axis parallel to the Z axis), the arm/turntable system may be considered a 7-DOF system. The 6-DOF robotic arm 430 includes three pitch joints 432, 434, and 436, and a 3-DOF wrist 438 which, in some embodiments, may be a spherical 3-DOF wrist.

Starting at the turntable 420, the robotic arm 430 includes a turntable offset 422, which is fixed relative to the turntable 420. A distal portion of the turntable offset 422 is rotatably coupled to a proximal portion of a first link 433 at a first joint 432. A distal portion of the first link 433 is rotatably coupled to a proximal portion of a second link 435 at a second joint 434. A distal portion of the second link 435 is rotatably coupled to a proximal portion of a third link 437 at a third joint 436. The first, second, and third joints 432, 434, and 436 are associated with first, second, and third axes 432a, 434a, and 436a, respectively.

The first, second, and third joints 432, 434, and 436 are additionally associated with first, second, and third actuators (not labeled) which are configured to rotate a link about an axis. Generally, the nth actuator is configured to rotate the nth link about the nth axis associated with the nth joint. Specifically, the first actuator is configured to rotate the first link 433 about the first axis 432a associated with the first joint 432, the second actuator is configured to rotate the second link 435 about the second axis 434a associated with the second joint 434, and the third actuator is configured to rotate the third link 437 about the third axis 436a associated with the third joint 436. In the embodiment shown in FIG. 3, the first, second, and third axes 432a, 434a, and 436a are parallel (and, in this case, are all parallel to the X axis). In the embodiment shown in FIG. 3, the first, second, and third joints 432, 434, and 436 are all pitch joints.

In some embodiments, a robotic arm of a highly integrated mobile manipulator robot may include a different number of degrees of freedom than the robotic arms discussed above. Additionally, a robotic arm need not be limited to a robotic arm with three pitch joints and a 3-DOF wrist. A robotic arm of a highly integrated mobile manipulator robot may include any suitable number of joints of any suitable type, whether revolute or prismatic. Revolute joints need not be oriented as pitch joints, but rather may be pitch, roll, yaw, or any other suitable type of joint.

Returning to FIG. 3, the robotic arm 430 includes a wrist 438. As noted above, the wrist 438 is a 3-DOF wrist, and in some embodiments may be a spherical 3-DOF wrist. The wrist 438 is coupled to a distal portion of the third link 437. The wrist 438 includes three actuators configured to rotate an end effector 450 coupled to a distal portion of the wrist 438 about three mutually perpendicular axes. Specifically, the wrist may include a first wrist actuator configured to rotate the end effector relative to a distal link of the arm (e.g., the third link 437) about a first wrist axis, a second wrist actuator configured to rotate the end effector relative to the distal link about a second wrist axis, and a third wrist actuator configured to rotate the end effector relative to the distal link about a third wrist axis. The first, second, and third wrist axes may be mutually perpendicular. In embodiments in which the wrist is a spherical wrist, the first, second, and third wrist axes may intersect.

In some embodiments, an end effector may be associated with one or more sensors. For example, a force/torque sensor may measure forces and/or torques (e.g., wrenches) applied to the end effector. Alternatively or additionally, a sensor may measure wrenches applied to a wrist of the robotic arm by the end effector (and, for example, an object grasped by the end effector) as the object is manipulated. Signals from these (or other) sensors may be used during mass estimation and/or path planning operations. In some embodiments, sensors associated with an end effector may include an integrated force/torque sensor, such as a 6-axis force/torque sensor. In some embodiments, separate sensors (e.g., separate force and torque sensors) may be employed. Some embodiments may include only force sensors (e.g., uniaxial force sensors, or multi-axis force sensors), and some embodiments may include only torque sensors. In some embodiments, an end effector may be associated with a custom sensing arrangement. For example, one or more sensors (e.g., one or more uniaxial sensors) may be arranged to enable sensing of forces and/or torques along multiple axes. An end effector (or another portion of the robotic arm) may additionally include any appropriate number or configuration of cameras, distance sensors, pressure sensors, light sensors, or any other suitable sensors, whether related to sensing characteristics of the payload or otherwise, as the disclosure is not limited in this regard.

As described above, some logistics operations performed by a robot may involve interaction with pallets. For example, during an order building task (also sometimes referred to as “palletizing” or “building a pallet”), the robot may be configured to place one or more objects onto a pallet. Prior to performing palletizing, the robot may require an empty pallet to be located within the workspace of the robot. For instance, the empty pallet may be loaded on a portion of the robot or on an accessory (e.g., a cart) coupled to or otherwise located near the robot. As another example, a robot tasked with organizing, stocking, and/or cleaning a warehouse environment may be configured to move and/or otherwise manipulate empty pallets in the warehouse environment. As further described above, manipulating empty pallets within a warehouse environment that utilizes robots for automating logistics operations is typically handled by human operators. For instance, a human may identify and/or select a proper pallet (e.g., an empty pallet of sufficient size and/or condition for the robot's task and/or capabilities) and provide the pallet to the robot (e.g., by placing the pallet in a location for the robot to place objects on, such as on a floor space, a portion of the robot, an accessory coupled to the robot, etc.). After being provided the pallet, the robot may proceed to complete the assigned task.

The inventors have recognized and appreciated that, in some instances, requiring a human operator to deliver and/or manipulate empty pallets may result in a decrease in efficiency of the robot in performing a warehouse operation. For example, requiring human intervention to manipulate empty pallets may increase the amount of downtime during which the robot is not performing a given task. By configuring the robot to manipulate empty pallets (e.g., by identifying, selecting, and grasping empty pallets) in accordance with one or more of the techniques described herein, at least some of such inefficiencies may be reduced or removed from logistical scenarios/workflows.

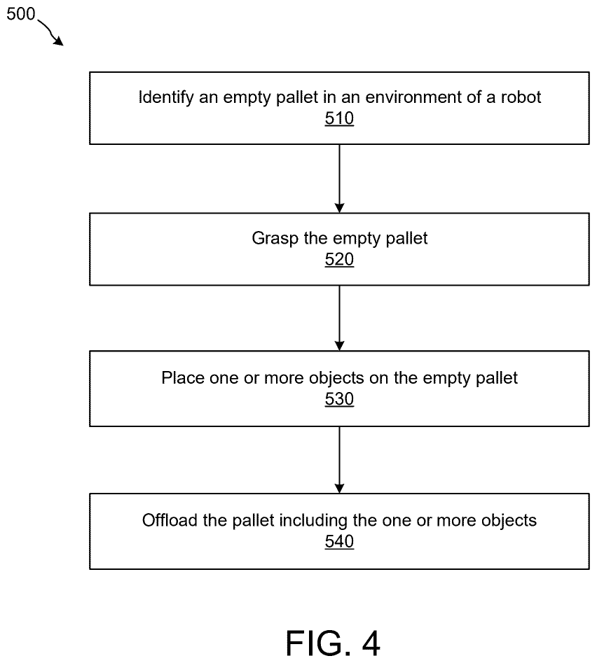

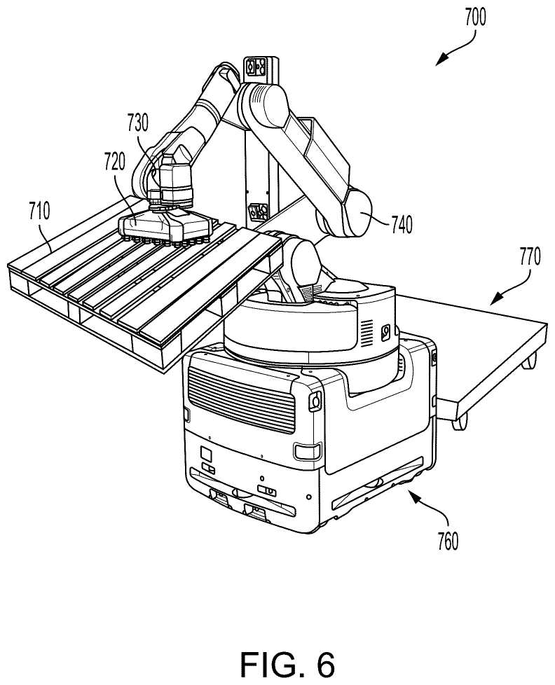

FIG. 4 is a flowchart of a process 500 for manipulating an empty pallet, in accordance with some embodiments. Process 500 may begin in act 510, where an empty pallet is identified in an environment of a robot. For instance, as discussed herein in connection with FIG. 6, a robot may identify an empty pallet using sensor data captured by one or more sensors, such as sensor(s) coupled to the robot and/or sensors external to the robot (e.g., sensors located in an environment of the robot).

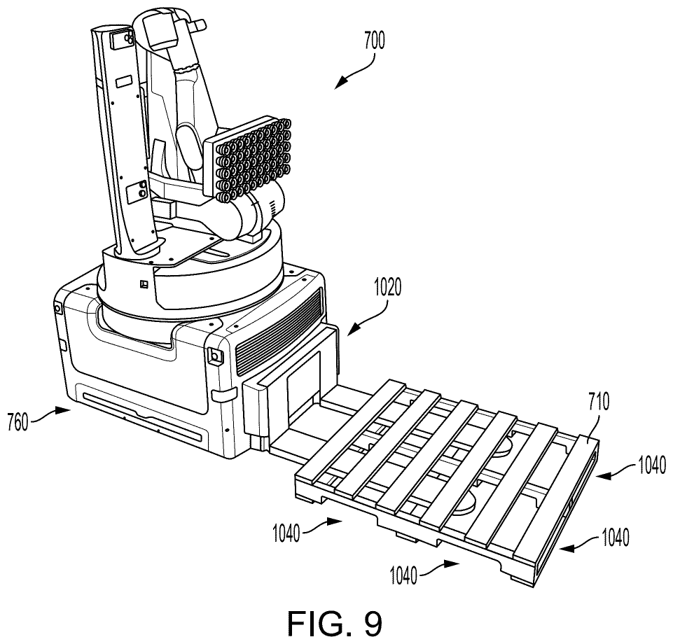

Process 500 may then proceed to act 520, where the robot may grasp the empty pallet. For example, as shown in FIG. 6, the robot may grasp the identified empty pallet using an end effector coupled to an arm of the robot, such as a robotic gripper (e.g., a vacuum-based gripper) or a mechanical accessory (e.g., a hook, a clamp, a robotic claw or hand, etc.) configured for grasping empty pallets. As a further example, the robot may grasp the empty pallet using a set of tines coupled to a portion of the robot, as shown in FIG. 9.

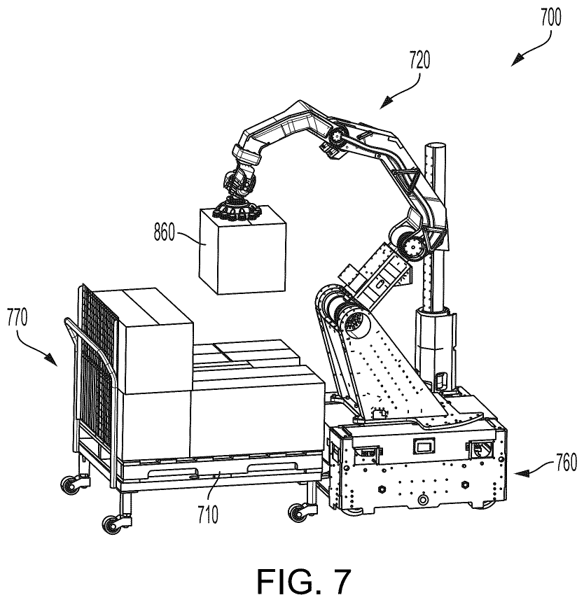

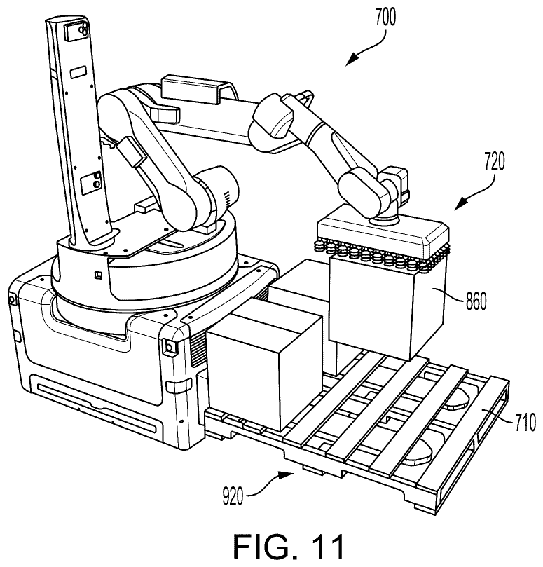

Process 500 may then proceed to act 530, where the robot may place one or more objects on the empty pallet. For instance, as shown in FIGS. 7 and 11, the robot may grasp boxes from the environment of the robot and place them on the empty pallet, which in some cases, may still be grasped by the robot (e.g., by the set of tines) or may be placed on an accessory coupled to or located near the robot, such as a cart accessory. As described herein, the grasping and placing of the objects on the empty pallet may be part of an order building task.

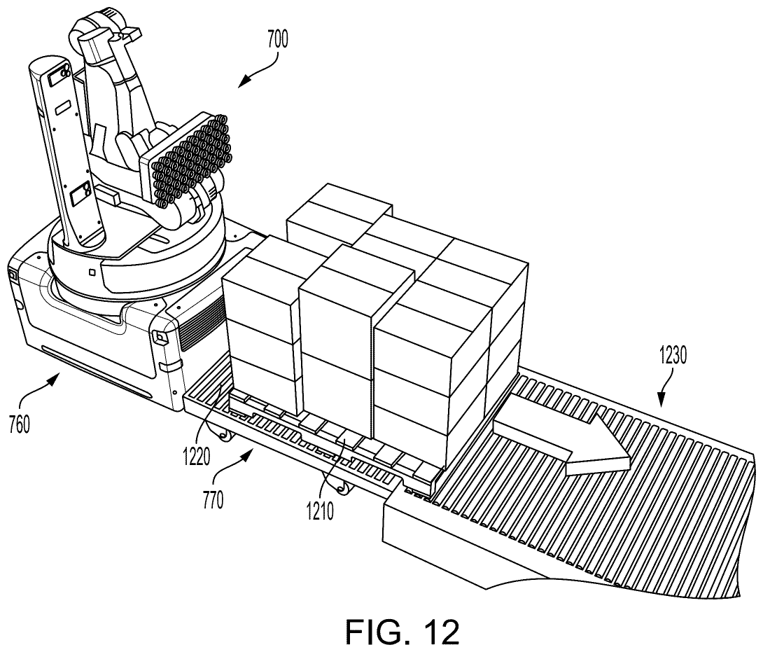

The result of performing act 530 may be a pallet including one or more objects arranged thereon. Process 500 may then proceed to act 540, where the robot may offload the pallet including the one or more objects. As shown in FIGS. 12-14, the robot may offload the pallet at a target destination, such as on a conveyor, on a floor of the environment, on wall-mounted tines, or at any other suitable location.

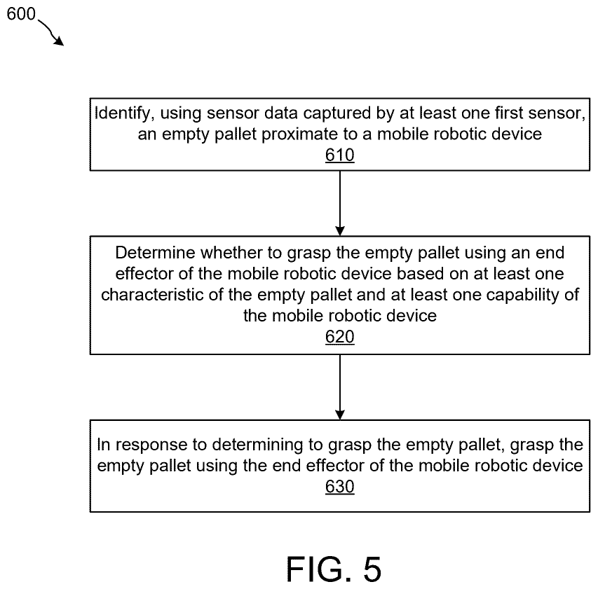

FIG. 5 is a flowchart of a process 600 for grasping an empty pallet, in accordance with some embodiments. Process 600 may begin in act 610, where an empty pallet proximate to a mobile robotic device is identified using sensor data captured by at least one first sensor. For instance, as discussed herein, the robot may receive sensor data from one or more sensors, which may be coupled to the robot and/or may be external to the robot, such as sensors located in an environment of the robot. The robot may identify that an object is an empty pallet based on classifying the object as an empty pallet with a threshold level of confidence, determining the sensor data includes an identifier tag identifying the empty pallet, and/or determining the robot is positioned at a location known to include empty pallets.

Process 600 may then proceed to act 620, where the robot may determine whether to grasp the empty pallet using an end effector of the mobile robotic device based on at least one characteristic of the empty pallet and at least one capability of the mobile robotic device. The characteristics of the empty pallet may include, but are not limited to, a pallet type of the empty pallet, a condition of the empty pallet, an estimated size of the empty pallet, or an estimated weight of the empty pallet. Additionally, the capabilities of the robot may include, but are not limited to, the ability of the robot to grasp empty pallets, such as whether the robot includes an end effector or another component configured to grasp an empty pallet, a maximum and/or minimum pallet size that the robot is configured to manipulate, and/or a maximum pallet weight that the robot is configured to manipulate.

The process 600 may then proceed to act 630, where, in response to determining to grasp the empty pallet, the robot may grasp the empty pallet using the end effector of the mobile robotic device. For instance, as shown in FIG. 6, the robot may grasp the empty pallet using a robotic gripper coupled to an arm of the robot.

FIG. 6 depicts a robot 700 including a mobile base 760 and a robotic arm 740. The robot 700 may be configured to manipulate an empty pallet 710 using an end effector coupled to the robotic arm 740, according to an illustrative embodiment of the invention. In particular, FIG. 6 depicts the robot 700 grasping the empty pallet 710 using a robotic gripper 720 (e.g., a suction or vacuum gripper) coupled to the robotic arm 740 of the robot 700. In some embodiments, the robot 700 may correspond (or be configured similarly) to the robot 400 discussed herein with respect to FIG. 3.

Prior to grasping an empty pallet (e.g., the empty pallet 710), the robot 700 may be configured to identify an empty pallet to be grasped by the robot 700. Identifying an empty pallet may include, for example, identifying that an object in an environment of robot 700 is (or is likely to be) a pallet. For example, the robot 700 may be configured to identify a pallet that is near the robot 700, such as within grasping distance of the robot. As another example, the robot 700 may be configured to identify a pallet that is in view of a sensor of or in driving distance from the robot 700 in the robot's environment.

Identifying an empty pallet may further include that the object identified as a pallet in the environment of the robot is empty. For example, after identifying that an object is a pallet, the robot 700 may identify whether the pallet is empty. In some embodiments, identifying an object is a pallet and identifying the pallet is empty may be performed in the same logical determination (e.g., the robot 700 may identify that an object is an empty pallet).

In some embodiments, the robot 700 may identify an empty pallet (e.g., the empty pallet 710) using sensor data captured by one or more sensors. For example, the one or more sensors may include sensor(s) coupled to the robot 700, such as the sensors discussed herein in connection with FIGS. 1A-1B and FIG. 3. In some embodiments, one or more of the sensors may include sensors external to the robot 700. For example, the robot 700 may identify the empty pallet 710, at least in part, using sensor data sensed by one or more sensors located in an environment (e.g., a warehouse, a truck/trailer, a loading dock, and/or any other logistic environment) of the robot 700. For instance, such sensors may be located on a wall, a ceiling, a floor, a post/pole, a shelf, another robot, etc. The one or more sensors may include one or more cameras, non-limiting examples of which include a two-dimensional (2D) camera, a stereoscopic camera, and/or a red-green-blue (RGB) monocular camera.

The robot 700 may include a controller of the robot 700 configured to receive and process the sensor data to identify the empty pallet 710. In some embodiments, the controller may be configured to identify the empty pallet based on determining the sensor data includes an object corresponding to an empty pallet. For example, the controller may be configured to apply computer vision techniques to determine whether an object included in the sensor data corresponds to a pallet, such as whether the object may be classified as an empty pallet with a threshold confidence. In some embodiments, the sensor data may include or indicate characteristics of the empty pallet, such as a pallet type, condition and/or size of the empty pallet, as described herein.

Alternatively, or additionally, the controller may be configured to identify the empty pallet 710 based on determining the sensor data includes an identifier tag identifying the empty pallet 710, such as a barcode. In some embodiments, the identifier tag may identify characteristics of the empty pallet 710, such as a pallet type, as discussed herein below. The controller may process the sensor data and, based on detecting the identifier tag, may identify the empty pallet 710.

Alternatively, or additionally, the controller may be configured to identify the empty pallet 710 based, at least in part, on a location of the robot 700 in an environment. For instance, the sensor data may indicate that the robot 700 is positioned at a particular location known to include empty pallets. In response to determining that the robot 700 is located at the particular location known to include empty pallets, the sensor data may be analyzed to identify an empty pallet at the location Alternatively, or additionally, the sensor data indicating the robot's location may be first sensor data and in response to determining based on the first sensor data that the robot 700 is located at the particular location known to include empty pallets, a sensor external to the robot 700 may be configured to send second sensor data to the robot 700. The second sensor data may be used, at least in part, to identify an empty pallet at that location. Alternatively, or additionally, the controller may be configured to determine the robot 700 is positioned at the location known to include empty pallets based, at least in part, on Global Positioning System (GPS) coordinates of the robot 700. For instance, when GPS coordinates of the robot 700 match GPS coordinates corresponding to the location known to include empty pallets, it may be determined that the robot 700 is located at a place in the environment known to include empty pallets. When it is determined that the robot 700 is located at a place in the environment known to include empty pallets, the controller may be configured to determine that an object included in the sensor data is an empty pallet.

The inventors have recognized and appreciated that improper and/or uninformed manipulation of an empty pallet by the robot 700 may result in undesirable operations. For example, an uninformed robot may grasp an empty pallet 710 using an unstable configuration, drop an empty pallet 710 if not properly grasped, and/or not be able to properly compensate for the empty pallet 710 when performing additional operations (e.g., moving about an environment). In some embodiments, after an empty pallet 710 has been identified, the robot 700 may be configured to determine whether and/or how to grasp the identified empty pallet 710.

In some embodiments, the robot 700 may determine whether to grasp the empty pallet 710 based on one or more characteristics of the empty pallet 710 and/or one or more capabilities of the robot 700. Characteristics of an empty pallet may include, but are not limited to, a pallet type of the empty pallet, a condition of the empty pallet, an estimated size of the empty pallet, or an estimated weight of the empty pallet. A pallet type of the empty pallet may include, but is not limited to, a manufacturer of the empty pallet, a product corresponding to the empty pallet, a material of the empty pallet, etc. A condition of an empty pallet may include, but is not limited to, an overall quality of the empty pallet, such as how worn the empty pallet appears, how warped the empty pallet appears, whether the empty pallet is whole or missing any portions (e.g., missing slats), whether the empty pallet has any obstructions within its structure, etc. A size of the empty pallet may include, but is not limited to, one or more estimated dimensions (e.g., length, width, and/or height) of the empty pallet or a pre-set size indication estimated to match the empty pallet (e.g., small, medium, large, etc.). In some embodiments, the characteristics of an empty pallet may be included in and/or estimated from the sensor data used to identify the empty pallet. Alternatively, or additionally, the characteristics of the empty pallet may be included in and/or estimated from further sensor data captured by the one or more sensors (e.g., after the empty pallet is identified). For example, the robot 700 may drive the mobile base 760 proximate to the empty pallet 710, and the one or more sensors may capture the sensor data, which may be used to determine the one or more characteristics of the empty pallet. Alternatively, or additionally, the robot 700 may receive the sensor data used to determine the one or more characteristics of the empty pallet from one or more sensors external to robot 700.

In some embodiments, the capabilities of the robot 700 may include the ability of the robot 700 to grasp empty pallets. For example, a robot 700 may be configured for grasping empty pallets if the robot 700 includes an end effector (e.g., the robotic gripper 720) or another component configured to grasp an empty pallet, such as a set of tines. In such instances, a controller of the robot 700 may be configured to control the robot 700 to grasp the empty pallets using the end effector or other component. In some embodiments, the capabilities of the robot 700 may further include a maximum and/or minimum pallet size that the robot 700 is configured to manipulate (e.g., grasp and/or move). In some embodiments, the capabilities of the robot 700 may further include a maximum pallet weight that the robot 700 is configured to manipulate.

In some embodiments, the robot 700 may be configured to use the one or more characteristics of the empty pallet 710 and/or the one or more capabilities of the robot 700 to determine whether and/or how to grasp the empty pallet 710. For example, when it is determined that the robot 700 is configured for grasping empty pallets, it may be determined that the robot 700 may grasp an identified empty pallet 710. Alternatively, or additionally, when it is determined that the condition of the empty pallet 710 meets and/or exceeds a threshold level or safety condition, it may be determined that the robot 700 may grasp the empty pallet 710. Alternatively, or additionally, when it is determined that the robot 700 is configured to manipulate empty pallets corresponding to an estimated size and/or weight, it may be determined that the robot 700 may grasp the empty pallet 710. Alternatively, or additionally, when it is determined that a pallet type of the empty pallet 710 matches that of a pallet to be grasped, such as for a particular task, it may be determined that the robot 700 may grasp the empty pallet 710. For example, the robot 700 may be configured to identify an empty pallet to be grasped as part of an order building task. The robot 700 may be configured to perform the order building task according to a set of instructions (e.g., order details), which may indicate the pallet type of the empty pallet, and/or other characteristics of the empty pallet, to be used for the order building task. It may be determined that the robot 700 may grasp the empty pallet 710 based on determining the pallet type of the empty pallet 710, and/or other characteristics of the empty pallet, match those indicated in the set of instructions.

In some situations, based on the characteristics of the empty pallet 710 and/or the capabilities of the robot 700, the robot 700 may be configured to determine not to attempt to manipulate the pallet. For instance, when it is determined that the robot 700 is not configured to grasp empty pallets, the robot 700 may determine not to attempt to grasp the empty pallet 710. Alternatively, or additionally, when it is determined that a condition of the empty pallet 710 does not meet a threshold level or safety condition, the robot 700 may determine to not attempt grasping the empty pallet 710. Alternatively, or additionally, when it is determined that the size of the empty pallet 710 is too large/small and/or too heavy for the robot 700 to manipulate, the robot 700 may determine not to attempt to grasp the empty pallet 710. Alternatively, or additionally, when it is determined that a pallet type of the empty pallet 710 does not match that of a pallet to be grasp, such as for a particular task, the robot 700 may determine to not attempt to grasp the empty pallet 710.

In some instances, the robot 700 may be configured to determine whether to attempt to grasp the empty pallet based, at least in part, on a location (e.g., a target location) in which the pallet is to be placed once the empty pallet has been grasped by the robot 700. For example, if the robot 700 is tasked with grasping an empty pallet and placing it in a particular target location, such as on a cart accessory 770 coupled to the robot 700, and it is determined that a size of the empty pallet is too large to fit at the target location, the robot 700 may determine not to attempt to grasp the empty pallet 710.

In response to determining to grasp an identified empty pallet, the robot 700 may grasp the empty pallet using an end effector coupled to the robot 700, such as the robotic gripper 720. In some embodiments, an example of which is depicted in FIG. 6, the robotic gripper 720 may be a vacuum-based (e.g., suction) robotic gripper including a plurality of vacuum assemblies. Each vacuum assembly may include a valve and a suction cup. The robot 700 may be configured to activate one or more of the vacuum assemblies (e.g., by providing suction to the one or more vacuum assemblies, such as from a vacuum source onboard the robot 700) to grasp the empty pallet 710. In some embodiments, the robot 700 may be configured to determine a seal quality of the one or more activated vacuum assemblies. For example, the vacuum assemblies may include sensors for measuring pressure for the vacuum assemblies when activated, which may be used by the robot 700 to determine a seal quality for the vacuum assemblies. If the seal quality of the activated vacuum assemblies is determined to be acceptable (e.g., meet or exceed a threshold seal quality), the robot 700 may determine the empty pallet 710 is grasped.

In some such embodiments, activated vacuum assemblies determined to have a seal quality less than a threshold may be disabled, by removing the suction provided to the vacuum assemblies. Thereafter, the robot 700 may reactivate the disabled vacuum assemblies to again determine if a seal quality meets or exceeds the threshold. In some embodiments, a score may be assigned to the disabled vacuum assemblies, where the disabled vacuum assemblies may be reactivated in an order of the assigned scores (e.g., sequentially).

In some embodiments, the robotic gripper 720 may further include or otherwise correspond to a mechanical accessory (e.g., a hook, a clamp, a robotic claw or hand, etc.) configured to grasp the empty pallet 710. The mechanical accessory may be coupled to the robotic gripper 720 or the robotic wrist 730 of the robotic arm 740. The robot 700 may contact the empty pallet 710 with the mechanical accessory to grasp the empty pallet 710. For example, the robot 700 may hook the mechanical accessory under a portion (e.g., a board) of the empty pallet 710 to grasp the empty pallet 710. As another example, after contacting the empty pallet 710 with the mechanical accessory, the robot 700 may actuate or close a clamp of the mechanical accessory to grasp a portion (e.g., a board) of the empty pallet 710.

In some embodiments, the robot 700 may determine how to grasp the empty pallet 710 based on the one or more characteristics of the empty pallet 710 and/or the one or more capabilities of the robot 700. For example, the robot 700 may grasp a particular portion of the empty pallet 710 or grasp the empty pallet 710 at a particular location (e.g., a grasping location) based on a condition of the empty pallet 710. For instance, the robot 700 may determine to grasp the empty pallet at a grasping location determined to have a condition that meets and/or exceeds a level or safety condition, rather than a grasping location determined to have a condition that does not meet and/or exceed the level or safety condition (e.g., a damaged portion of the empty pallet 710). Alternatively, or additionally, the robot 700 may grasp a particular portion of the empty pallet 710 or grasp the empty pallet 710 at a particular location based on an estimated size and/or weight of the empty pallet 710, such as to properly support/balance the empty pallet 710. Alternatively, or additionally, the robot 700 may grasp a particular portion of the empty pallet 710 or grasp the empty pallet 710 at a particular location based on a pallet type of the empty pallet 710 (e.g., a pre-determined grasping location specific to the pallet type).

In some embodiments, the robot 700 may determine how to grasp the empty pallet 710 based on a location (e.g., a target location) in which the pallet is to be placed once the empty pallet 710 has been grasped by the robot 700. For example, the robot 700 may grasp a particular portion of the empty pallet 710 or grasp the empty pallet 710 at a particular location (e.g., a grasping location) based on the target location to place the empty pallet. For example, if the empty pallet 710 is to be lowered onto a location (e.g., a floor, a vertical-facing container, a surface with a high ceiling, etc.), then the robot 700 may grasp the empty pallet 710 at a grasping location allowing for vertical manipulation (e.g., raising or lowering) of the empty pallet (e.g., a top/center of the pallet). As another example, if the empty pallet 710 is to be placed into an enclosed location (e.g., a middle shelf, a container, or a location with a low ceiling), then the robot 700 may grasp the empty pallet XXA10 at a grasping location allowing for sliding or inserting of the empty pallet 710 (e.g., a side of the pallet, towards an edge of the pallet, off-center of the pallet) into the location. Alternatively, or additionally, the robot 700 may be configured to determine how to grasp the empty pallet 710 based, at least in part, on the end effector (e.g., the robotic gripper 720, such as the vacuum-based robotic gripper, mechanical accessory, etc.) to be used to grasp the empty pallet 710, as described above.

In some embodiments, the robot 700 may be configured to position itself to grasp the empty pallet 710. For example, the robot 700 may drive the mobile base 760 to a location proximate (e.g., within reach of the end effector) to the empty pallet 710 to facilitate the grasping of the empty pallet 710 using the end effector.

After grasping the empty pallet 710, the robot 700 may place the empty pallet 710 at a target location. For example, the robot 700 may place the empty pallet 710 on the cart accessory 770 coupled to the robot 700.

The robot 700 may be configured to rotate the robotic arm 740 so that the robotic gripper 720 and the empty pallet 710 are positioned over the cart accessory 770. The robot 700 may place the empty pallet 710 onto the cart accessory 770 and release the empty pallet 710 from the grasp of the robotic gripper 720 (e.g., by disabling the vacuum assemblies, disabling or opening a clamp, or tilting one or more of a robotic arm coupled to the robotic gripper, a robotic wrist coupled to the robotic arm and the robotic gripper, or the robotic gripper 720, to release the mechanical accessory from the empty pallet 710, etc.). As another example, the robot 700 may be configured to place the empty pallet on a portion of the robot 700, such as a flat portion of the robot 700 configured for loading of an empty pallet. As another example, the robot 700 may be configured to place the empty pallet on the floor, a truck bed, a shelf, a conveyor, another robot, a loading area, a storage area, onto another empty pallet (e.g., for storage or consolidation), etc. In some embodiments, placing the empty pallet at the target location may include driving the mobile base 760 of the robot 700 to the target location and placing the empty pallet at the target location.

FIG. 7 depicts a robot 700 configured to couple to a cart accessory 770. In some embodiments, the cart accessory 770 may be detachably coupled to the robot 700 (e.g., a mobile base 760 of the robot 700), via one or more coupling components (e.g., one or more electrical and/or mechanical coupling components. In some embodiments, the cart accessory 770 may be fixedly coupled to the robot 700 (e.g., the mobile base 760 of the robot 700). The cart accessory 770 may be configured to support a pallet (e.g., the empty pallet 710) on which boxes 860 or other objects (e.g., other empty pallets) can be placed. As such, after grasping the empty pallet 710, the robot 700 may place the empty pallet 710 on the cart accessory 770, and begin loading objects onto the empty pallet 710. In some embodiments, identifying and grasping an empty pallet may include the robot 700 identifying a cart accessory 770 having an empty pallet placed thereon, and coupling the cart accessory 770 with the empty pallet 710 to the robot 700. As shown in FIG. 7, after placing the empty pallet 710 on the cart accessory 770, the robot 700 may place boxes or other objects (e.g., other empty pallets) grasped by the robotic gripper 720 of the robot 700 onto the empty pallet 710.

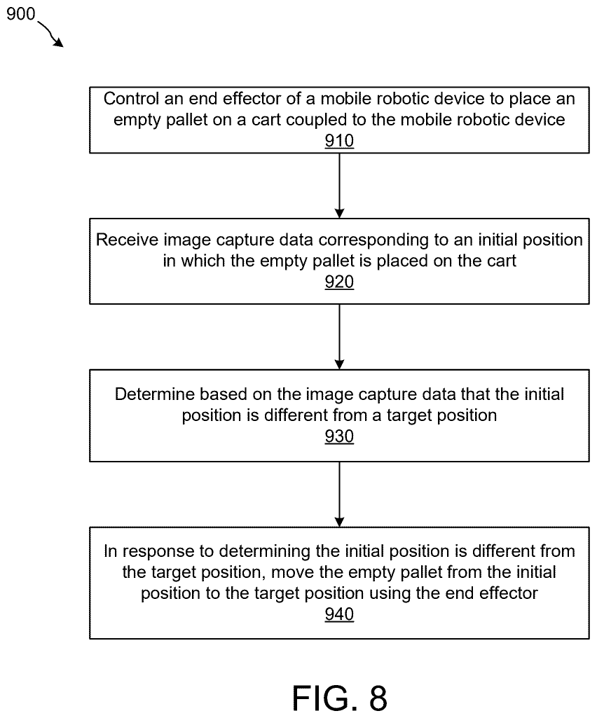

FIG. 8 is a flowchart of a process 900 for adjusting a position of an empty pallet. Process 900 may begin in act 910, where an end effector of a mobile robotic device is controlled to place an empty pallet on a cart coupled to the mobile robotic device. For instance, as shown in FIGS. 6 and 7, after grasping the empty pallet, the robot may place the empty pallet on a cart accessory coupled to the robot.

Process 900 may then proceed to act 920, where image capture data corresponding to an initial position in which the empty pallet is placed on the cart is received. For example, as discussed herein, the robot may be configured to receive the image capture data from one or more sensors, which may be coupled to the robot and/or may be located external to the robot (e.g., located in an environment of the robot).

Process 900 may then proceed to act 930, where it is determined that the initial position is different from a target position based on the image capture data. For instance, as discussed herein, the robot may be configured to determine whether the empty pallet is positioned in a target position on the cart, which may be a position that properly supports/balances the empty pallet. The robot may compare the initial position in which the empty pallet is placed on the cart, represented in the image capture data, to the target position to determine whether the initial position corresponds to the target position.

Process 900 may then proceed to act 940, where, in response to determining the initial position is different from the target position, the empty pallet may be moved from the initial position to the target position using the end effector. For example, the robot may be configured to use the end effector to push or nudge the empty pallet from the initial position toward the target position on the cart. As another example, the robot may be configured to use the end effector to pull the empty pallet from the initial position toward the target position on the cart.

As discussed herein above in connection with FIG. 8, in some embodiments, the robot 700 may be configured to adjust a position in which the empty pallet 710 is placed at a target location, such as on the cart accessory 770 coupled to the robot, a portion of the robot, the floor, a truck bed, a shelf, a conveyor, another robot, a loading area, a storage area, another empty pallet, etc. For example, if the robot 700 uses an end effector to place the empty pallet 710 on the cart accessory 770, the robot 700 may attempt to place the empty pallet 710 in a target position on the cart, such as a position that properly supports/balances the empty pallet 710, is likely to properly support one or more objects placed on the empty pallet 710, and/or facilitates safe operation of the robot 700 when the robot 700 drives around the environment (e.g., where the empty pallet 710 doesn't unnecessarily jut out from a profile of the robot 700 and/or the cart and/or where the empty pallet 710 likely won't fall off the cart).

As such, in some embodiments, the robot 700 may check that the empty pallet 710 was placed, or is still in, the target position. For example, one or more sensors may capture sensor data corresponding to a position (e.g., an initial position) that the empty pallet 710 was placed and/or is currently positioned on/at the target location (e.g., the cart accessory 770). As discussed above, the one or more sensors may correspond to sensors included on the robot 700 and/or external to the robot 700. The robot 700 may be configured to process the sensor data to determine whether the current position of the empty pallet 710 matches the target position. In some embodiments, the robot 700 may be configured to determine the current position of the empty pallet 710 by processing the sensor data to estimate the current position of the empty pallet 710 relative to the target location. Based on the estimated position of the empty pallet 710, the robot 700 may be configured to determine whether the estimated position of the empty pallet 710 matches or is within some tolerance of the target position. If the current position of the empty pallet 710 matches, or is within some tolerance of, the target position, the robot 700 may continue to operate to complete its task, such as loading objects onto the empty pallet 710, moving the robot 700 and the empty pallet 710 around an environment, and/or placing the empty pallet at a target location.

If the current position of the empty pallet 710 is determined not to match, or not be within some tolerance of, the target position (e.g., is different from the target position), the robot 700 may adjust a position of the empty pallet 710 from the current (e.g., initial) position into the target position. For example, the robot 700 may again grasp the empty pallet 710 using the end effector (e.g., using the robotic gripper 720, as discussed herein) and move/place the empty pallet 710 to/in the target position. As another example, the robot 700 may be configured to move the empty pallet 710 from the current position to the target position using the end effector, without grasping the empty pallet 710. In some instances, the robot 700 may push or nudge the empty pallet 710 into the target position using the end effector. For example, the robot 700 may use a portion (e.g., a distal or side portion) of the end effector to push against a proximal or side portion of the empty pallet 710 and towards the target position. In other instances, the robot 700 may be configured to pull the empty pallet 710 into the target position using the end effector. For example, the robot 700 may use a portion (e.g., a proximal portion) of the end effector to apply a force to a distal portion of the empty pallet directed towards the robot 700 and the target position.

After adjusting the position of the empty pallet 710, the robot 700 may once again determine whether the current position of the empty pallet 710 matches the target position, as described herein. Adjustment of the position of the empty pallet 710 may continue as described until the robot 700 determines the current position of the empty pallet 710 matches the target position (e.g., within some tolerance). Once the empty pallet is determined to be in the target position, the robot 700 may continue to operate to complete its task, such as loading objects onto the empty pallet 710, moving the robot 700 and the empty pallet 710 around an environment, and/or placing the pallet at a target location.

FIG. 9 depicts a robot 700 grasping an empty pallet 710 using a set of tines 1020 of the robot 700, according to an illustrative embodiment of the invention. As depicted in FIG. 9, the robot 700 may include a set of tines 1020 configured to manipulate (e.g., grasp and secure during movement of the robot 700) pallets, such as the empty pallet 710. The set of tines 1020 may be coupled to the mobile base 760 of the robot 700, such as a front, back, or side of the mobile base. The set of tines 1020 may be configured to grasp and/or secure a pallet, such as the empty pallet 710. For example, the set of tines 1020 may be inserted into fork openings 1040 of the empty pallet 710 and extended throughout at least a portion of the length of the empty pallet 710 to grasp and/or secure the empty pallet 710. Fork openings of a pallet may include openings on the underside of the pallet intended as an interface for manipulating the pallet, such as using fork tines. Although FIG. 9 depicts an example empty pallet 710 having one or more fork openings, any pallet configuration that may be manipulated using fork tines may be suitable.

The robot 700 including the set of tines 1020 may be configured to operate as discussed herein with respect to FIGS. 4-6 to identify and determine whether to grasp the empty pallet 710. Alternatively, or additionally, the robot 700 may be configured to determine whether to grasp the empty pallet 710 based on an estimated dimensions (e.g., height and/or width) and/or condition of the fork openings of the empty pallet 710. For example, prior to attempting to grasp the identified empty pallet 710, the robot 700 may determine whether the fork openings 1040 of the empty pallet 710 are wide and/or tall enough to insert the set of tines 1020. If the robot 700 determines that the fork openings 1040 are not wide and/or tall enough, the robot 700 may determine to not attempt to grasp the empty pallet 710. As another example, the robot 700 may be configured to determine whether a condition of the fork openings 1040 indicate that the robot 700 will likely be able to grasp the empty pallet 710 using the set of tines 1020. If not (e.g., the fork openings 1040 are too worn, too warped, include obstructions, etc.), the robot 700 may determine to not attempt to grasp the empty pallet 710.

As discussed herein, the robot 700 may be configured to grasp the empty pallet by inserting the set of tines 1020 into the fork openings 1040 of the empty pallet 710. The robot 700 may drive the mobile base 760 of the robot 700 towards the empty pallet to insert the set of tines 1020 through the fork openings 1040 of the empty pallet 710. The empty pallet 710 may be considered grasped once the set of tines 1020 are inserted up to a threshold length into the fork openings 1040, as described herein.

In some embodiments, the robot 700 may be configured to grasp the empty pallet 710 using an end effector coupled to a robotic arm 740 of the robot 700 and the set of tines 1020. The robot 700 may use the end effector (e.g., the robotic gripper) to manipulate the empty pallet 710 onto the set of tines 1020. For example, the end effector may be used to grasp the empty pallet 710 and the robot 700 may be controlled to move the grasped empty pallet 710 onto the set of tines 1020. As another example, the robot 700 may be configured to pull the empty pallet 710 onto the set of tines 1020. For instance, the empty pallet 710 may be slid across a surface onto the set of tines 1020 using the end effector.

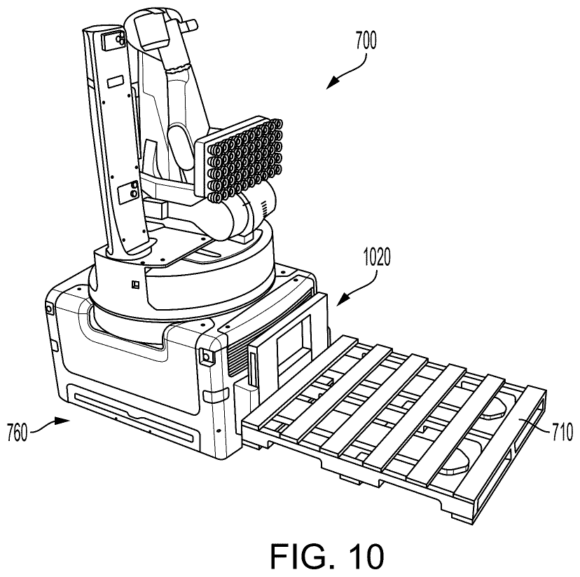

FIG. 10 depicts a robot 700 manipulating an empty pallet 710 grasped using a set of tines 1020, according to an illustrative embodiment of the invention. As depicted in FIG. 10, the set of tines 1020 may be configured to lift and lower a pallet grasped by the set of tines 1020. For example, after grasping a pallet using the set of tines 1020, a tines lift may be actuated to lift the set of tines 1020, thereby lifting the pallet off of its resting location.

As discussed above, in some embodiments, the robot 700 may be configured to grasp an empty pallet using an end effector and the set of tines 1020. In some such embodiments, the empty pallet 710 may be moved onto the set of tines 1020 using the end effector by raising the set of tines 1020 (e.g., into a space and/or to meet a raised surface) or lowering the set of tines 1020 (e.g., to a surface, such as the floor) using the tines lift.

In some embodiments, the set of tines 1020 may include wheels (e.g., caster wheels). For example, the set of tines 1020 may include caster wheels coupled to the bottom of the set of tines 1020, which may be configured to roll across a surface. In some such embodiments, grasping the empty pallet 710 may include resting the wheels of the set of tines 1020 on a surface including the empty pallet 710 and driving the set of tines 1020 through the fork openings 1040 of the empty pallet 710.

In some such embodiments, the set of tines 1020 may include support structures (e.g., “caster bases”), which may include one or more of the caster wheels. The caster bases may be coupled to the outer edges of the set of tines 1020 and extend parallel to the set of tines 1020. The caster bases may be configured to support (e.g., to prevent the tipping of) the robot 700 when grasping and/or manipulating (e.g., lifting and/or lowering) the empty pallet 710, such as by repositioning (e.g., lowering) a center of gravity and/or further distributing a weight of the robot 700. In some such embodiments, the caster bases may include foldable elbow joints, such that the caster bases may be folded in/out as needed. For example, the caster bases may be configured to fold out to support the grasping and/or lifting of a pallet, such as an empty pallet. Once the pallet is grasped and/or lifted, the caster bases may be configured to be folded in, such as under the set of tines 1020. In some embodiments, the caster bases may be powered to extend the caster bases and provide additional support and/or grasping capabilities for wider and/or heavier pallets. For example, the caster bases may be extended to facilitate the grasping and/or lifting of a pallet to provide more support than the caster bases may provide if they weren't extended. Once the pallet is grasped and/or lifted, the extended caster bases may be retracted.

In embodiments where the robot 700 includes the set of tines 1020, the robot 700 may include additional sensors (e.g., LiDAR sensors) coupled to the mobile base 760 and/or the caster bases (e.g., near the distal end of the caster bases) to enable the robot 700 to further sense the environment and/or objects near the set of tines 1020.

After grasping the empty pallet 710 using the set of tines 1020, the robot 700 may be configured to load the empty pallet 710 with objects, move around its environment (e.g., via the mobile base 760), and/or position itself at a target location to drop off the pallet, as discussed herein.

As discussed above, in some embodiments, the robot 700 may be configured to adjust a positioning of the empty pallet 710 placed on or at a target location. In some such embodiments, the target location may correspond to the set of tines 1020, such that the robot 700 may be configured to adjust a positioning of the empty pallet 710 as grasped by the set of tines 1020. The robot 700 may, therefore, be configured to determine whether the current position (e.g., initial position) in which the empty pallet 710 is positioned (e.g., grasped, lifted, etc.) on the set of tines 1020 matches a target position, which may be determined using further sensor data captured by one or more sensors of the robot 700 or an environment in which the robot 700 is operating. If the robot 700 determines the current position of the empty pallet 710 does not match the target position, the robot 700 may adjust a position of the empty pallet 710 from the current position to the target position. For example, the target position of the empty pallet 710 with respect to the set of tines 1020 may correspond to a particular distance with which the set of tines 1020 of the set of tines 1020 is inserted into the fork openings 1040 of the empty pallet 710. As another example, the target position of the empty pallet 710 with respect to the set of tines 1020 may correspond to a perceived balance of the empty pallet 710, as lifted by the set of tines 1020. The empty pallet 710 may be determined to be not in the target position if the empty pallet 710 appears to be off-balance, such as tilted or at an angle. As another example, the target position of the empty pallet with respect to the set of tines 1020 may correspond to a current height of the empty pallet, as lifted by the set of tines 1020.

In some instances, the robot 700 may be configured to adjust a position of the empty pallet 710 from the current position to the target position using the end effector of the robot (e.g., the robotic gripper 720). For example, the robot 700 may be configured to grasp the empty pallet 710 using the end effector, as described herein, and adjust a position of the empty pallet 710 from the current position to the target position on the set of tines 1020 before releasing the empty pallet 710. As another example, the robot 700 may be configured to push or nudge the empty pallet 710 into the target position using a portion of the end effector. For instance, the robot 700 may apply a force to a portion (e.g., a proximal portion or a side(s)) of the empty pallet 710 using a distal or side portion of the end effector to move the empty pallet 710 into the target position on the set of tines 1020, such as by balancing (e.g., centering) the empty pallet 710 on the set of tines 1020. As another example, the robot 700 may be configured to pull the empty pallet 710 into the target position using a portion of the end effector. For instance, the robot 700 may apply a force to a distal portion of the empty pallet 710 using a proximal portion of the end effector to move (e.g., slide) the empty pallet 710 into the target position, such as by further inserting the set of tines 1020 into the fork openings 1040 of the empty pallet 710.

In some instances, the robot 700 may be configured to adjust a position the empty pallet 710 from the current position to the target position using the set of tines 1020. For example, the robot 700 may be configured to actuate the tines lift of the set of tines 1020 to raise or lower the empty pallet 710 into the target position. Additionally or alternatively, in some instances, the robot 700 may be configured to adjust a position of the empty pallet 710 from the current position to the target position by driving a mobile base 760 towards the empty pallet 710, while the empty pallet 710 is resting on a surface, to further insert the set of tines 1020 into the fork openings 1040 of the empty pallet 710 and/or recenter the set of tines 1020 with respect to the empty pallet 710.

FIG. 11 depicts a robot 700 loading objects onto an empty pallet 710 grasped using a set of tines 1020, according to an illustrative embodiment of the invention. As depicted in FIG. 11, after grasping the empty pallet 710, the robot 700 may be configured to grasp and place boxes 860 or other objects on the empty pallet 710 using the robotic gripper 720. In some embodiments, set of tines 1020 may be lifted using the tines lift, to raise the empty pallet 710 for the loading process.

As described herein, after grasping an empty pallet and determining it has been placed in a target position, the robot 700 may perform additional operations to complete a task, such as an order building/palletizing task. Typically, after the robot 700 has completed such a task, a human operator may offload the completed pallet from the robot 700 to a target location, such as a pallet wrapping location, a truck loading location, a quality assurance location, a storage location, etc.

The inventors have recognized and appreciated that, in some instances, requiring a human operator to offload a pallet (e.g., a pallet after an order building task is completed) may result in a decrease in efficiency of the robot 700. In some embodiments, a robot may be configured to offload pallets from the robot (e.g., from a portion of the robot, a cart accessory coupled to the robot, a set of tines coupled to the robot, etc.) to a target location without the need for human intervention, which may improve the robot's efficiency in performing tasks that involve manipulation of a pallet.

FIG. 12 depicts a robot 700 offloading a loaded pallet 1210 from a cart accessory 770 to target destination, in accordance with some embodiments. Although FIG. 12 shows a process for offloading a loaded pallet 1210, it should be appreciated that a similar process may be used to offload a partially loaded pallet, and empty pallet, or a stack of empty pallets. As depicted in FIG. 12, the cart accessory 770 may be coupled to the robot 700, such as to a mobile base 760 of the robot 700. The cart accessory 770 may include a set of rollers 1220 operatively coupled to the cart accessory 770. The set of rollers 1220 may be configured to facilitate the offloading of the loaded pallet 1210 to a target destination, such as to a conveyor 1230.

The mobile base 760 of the robot 700 may be configured to drive the robot 700 to the target destination. For example, the robot 700 may include a controller configured to determine the target location to which the loaded pallet 1210 is to be offloaded, such as GPS coordinates of the target location, and the mobile base 760 may be configured to drive to the target location. The controller of the robot 700 may additionally be configured to identify that the robot 700 is located at or proximate to the target destination. For example, the controller of the robot 700 may be configured to identify that the GPS coordinates of the robot 700 correspond to or are proximate to the target destination. As another example, the controller of the robot may be configured to receive and process sensor data from one or more sensors, such as sensors coupled to the robot 700 and/or located in an environment including the robot 700, to determine the sensor data includes an identifier tag identifying the target destination.

In some embodiments, the target location to which the loaded pallet 1210 (or the empty pallet 710) is to be offloaded may be based on characteristics of the loaded pallet 1210 (or the empty pallet 710). For example, the target location to which the loaded pallet 1210 may be based on a pallet type of the loaded pallet 1210, where a first loaded pallet 1210 may be offloaded to a first target location based on the first loaded pallet 1210 being of a first pallet type and a second loaded pallet 1210 may be offloaded to a second target location based on the second loaded pallet 1210 being of the second pallet type. For further example, the target location to which the empty pallet 710 is to be offloaded may be based on a condition of the empty pallet 710, where a first empty pallet 710 determined to be in a first condition (e.g., a good condition) may be offloaded to a first target location and a second empty pallet 710 determined to be in a second condition (e.g., a poor condition) may be offloaded to a second target location.

The robot 700 may be configured to properly position loaded pallet 1210 and/or the cart accessory 770 with respect to the target destination to enable the offloading of the loaded pallet 1210. For example, a mobile base 760 of the robot 700, such as side of the mobile base 760 that is coupled to the cart accessory 770, may be driven towards the target destination (e.g., in the depiction of FIG. 12, the conveyor 1230) until the loaded pallet 1210 and/or the cart accessory 770 arrives at the target destination or is within a threshold distance from the target destination. For instance, the controller of the robot 700 may be configured to receive and process sensor data (e.g., image capture data, proximity data, etc.) received from the one or more sensors, to determine when the loaded pallet 1210 and/or the cart accessory 770 is in the proper position for offloading.

The loaded pallet 1210 may be offloaded from the cart accessory 770 to a target destination, such as the conveyor 1230, using the robot 700 and/or the cart accessory 770. For example, in some embodiments, the set of rollers 1220 of the cart accessory 770 may be passive, such that the set of rollers are configured to rotate in response to a horizontal or sliding force being applied across a top surface of the set of rollers 1220. For instance, as shown in FIG. 12, the set of rollers 1220 may be configured to passively rotate in response to the loaded pallet 1210 being slid off of the cart accessory 770. In such embodiments, the robot may be configured to push or nudge the loaded pallet 1210 towards the target destination (e.g., the conveyor 1230) using an arm (e.g., the arm 740) of the robot and/or an end effector (e.g., e.g., the robotic gripper 720) of the robot. As another example, in some embodiments, the set of rollers 1220 may additionally or alternatively be powered, such that the set of rollers may be actuated to rotate and offload the loaded pallet 1210 to the target destination. As an additional example, in some embodiments, the cart accessory 770 may be configured to raise and/or tilt. For instance, the cart accessory 770 may include an actuator configured to raise and tilt a portion of the cart accessory 770 away from the robot 700, such that the loaded pallet 1210 is offloaded from (e.g., slid off of) the cart accessory to the target destination. In such implementations, the cart accessory 770 may include a stopping component disposed at a distal end of the cart accessory 770 of the robot 700. When the portion of the cart accessory 770 is raised and tilted away from the robot, the stopping component may be configured to stop the loaded pallet 1210 from being offloaded from (e.g., sliding off of) the cart accessory 770. The stopping component may include an actuator configured to disengage the stopping component after raising and tilting the portion of the cart accessory 770, such that the loaded pallet 1210 may be offloaded from the cart accessory 770.

In some embodiments, the cart accessory 770 may be detachably coupled to the robot 700 (e.g., the mobile base 760 of the robot 700), such as via a coupling component of the robot 700 and/or the cart accessory 770. In some such embodiments, the robot 700 may be configured to offload the loaded pallet 1210 to the target destination by detaching the cart accessory 770 including the loaded pallet 1210 from the robot 700 at the target destination. For example, the coupling component may be configured to receive and process a command to decouple the cart accessory 770 from the robot 700. For further example, the target destination may include a decoupling component (e.g., a docking station, a wall mounted component, etc.) configured to interface with (e.g., couple to) the cart accessory 770 (e.g., a same or different coupling component), such that the cart accessory 770 is detached from the robot 700. For instance, the robot 700 may be configured to drive the cart accessory 770 towards the target destination to interface with the decoupling component. After interfacing with the decoupling component, the robot 700 may be configured to drive away from the target destination, which may detach the cart accessory 770 from the robot 700. In some such examples, the interfacing of the cart accessory 770 with the decoupling component may detach the cart accessory 770 from the robot 700.

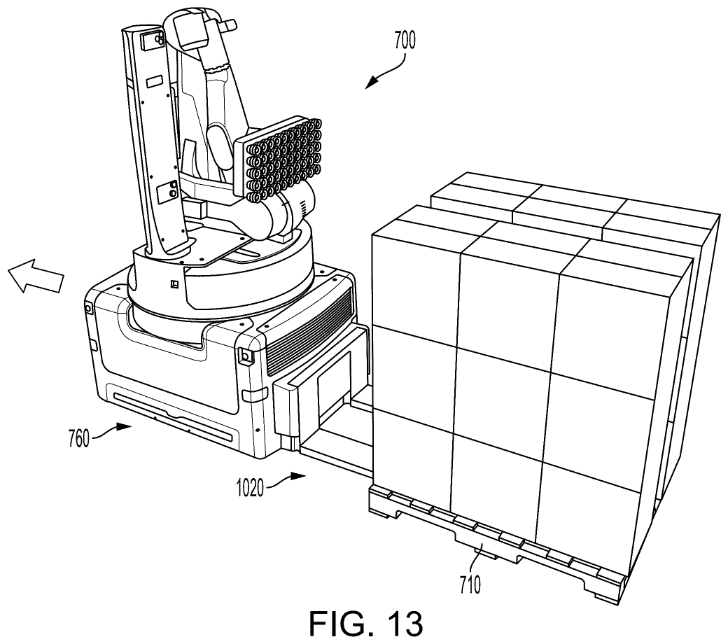

FIG. 13 depicts a robot 700 offloading a loaded pallet 1210 from a set of tines 1020 to a target destination, in accordance with some embodiments. For example, as depicted in FIG. 13, the loaded pallet 1210 may be offloaded from a set of tines coupled to the robot 700 to a floor of an environment in which the robot 700 is operating. As further depicted in FIG. 13, prior to offloading the loaded pallet 1210, the loaded pallet 1210 may be grasped by the set of tines 1020, which may be inserted into fork openings of the loaded pallet 1210.

A mobile base 760 of the robot 700 may be configured to drive the robot 700 to the target destination, which may be determined by a controller of the robot 700. The controller of the robot 700 may be configured to determine the robot 700 is located at or proximate to the target destination and determine the loaded pallet is properly positioned 1210 for offloading to the target destination.

The loaded pallet 1210 may be offloaded from the set of tines 1020 to the target destination by using a tines lift component of the set of tines 1020, which may be configured to lower the set of tines 1020 and the loaded pallet 1210 to the target destination. For example, the tines lift component may be used to lower the loaded pallet 1210 to rest on a surface of the target destination. In some embodiments, the robot 700 may be configured to determine that the loaded pallet 1210 has been placed on or at the target destination using sensor data received from one or more sensors, such as sensors coupled to the robot 700 and/or included in an environment of the robot 700.

After the loaded pallet 1210 has been placed on or at the target destination, a mobile base 760 of the robot may be driven away from the loaded pallet 1210 (e.g., in a direction opposite the loaded pallet 1210 and/or the set of tines 1020), such that the set of tines 1020 is removed from the fork openings of the loaded pallet 1210. In some embodiments, the mobile base 760 may be configured to drive away from the loaded pallet 1210 until the robot 700 determines that the set of tines 1020 has been removed from the fork openings of the loaded pallet 1210. For example, the robot 700 may be configured to determine that the set of tines 1020 has been removed using sensor data received from the one or more sensors.

In some embodiments, the target destination may be a set of wall-mounted (or other surface-mounted) tines configured to offload the empty pallet 710 from the robot 700. For example, the mobile base 760 may be configured to drive the robot 700 towards the set wall-mounted tines, such that the set of wall-mounted tines are inserted into the fork openings of the empty pallet 710. In instances where the empty pallet 710 is grasped by the set of tines 1020, the tines lift component may be configured to lower the empty pallet 710 so that the empty pallet 710 is supported by the set of wall-mounted tines, instead of the set of tines 1020. Thereafter, the mobile base 760 may be configured to drive the robot 700 away from the wall-mounted tines and remove the set of tines 1020 from the empty pallet 710.

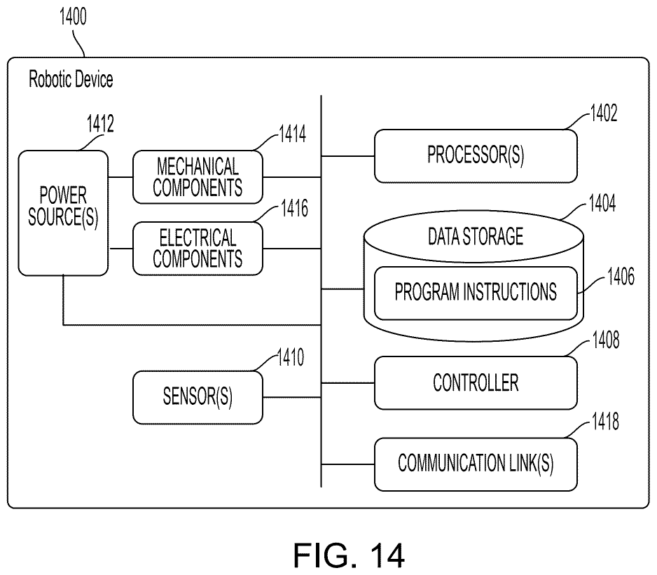

FIG. 14 illustrates an example configuration of a robotic device (or “robot”) 1400, according to an illustrative embodiment of the invention. The robotic device 1400 represents an example robotic device configured to perform the operations described herein. Additionally, the robotic device 1400 may be configured to operate autonomously, semi-autonomously, and/or using directions provided by user(s), and may exist in various forms, such as a humanoid robot, biped, quadruped, or other mobile robot, among other examples. Furthermore, the robotic device 1400 may also be referred to as a robotic system, mobile robot, or robot, among other designations.

As shown in FIG. 14, the robotic device 1400 includes processor(s) 1402, data storage 1404, program instructions 1406, controller 1408, sensor(s) 1410, power source(s) 1412, mechanical components 1414, and electrical components 1416. The robotic device 1400 is shown for illustration purposes and may include more or fewer components without departing from the scope of the disclosure herein. The various components of robotic device 1400 may be connected in any manner, including via electronic communication means, e.g., wired or wireless connections. Further, in some examples, components of the robotic device 1400 may be positioned on multiple distinct physical entities rather on a single physical entity. Other example illustrations of robotic device 1400 may exist as well.

Processor(s) 1402 may operate as one or more general-purpose processor or special purpose processors (e.g., digital signal processors, application specific integrated circuits, etc.). The processor(s) 1402 can be configured to execute computer-readable program instructions 1406 that are stored in the data storage 1404 and are executable to provide the operations of the robotic device 1400 described herein. For instance, the program instructions 1406 may be executable to provide operations of controller 1408, where the controller 1408 may be configured to cause activation and/or deactivation of the mechanical components 1414 and the electrical components 1416. The processor(s) 1402 may operate and enable the robotic device 1400 to perform various functions, including the functions described herein.

The data storage 1404 may exist as various types of storage media, such as a memory. For example, the data storage 1404 may include or take the form of one or more computer-readable storage media that can be read or accessed by processor(s) 1402. The one or more computer-readable storage media can include volatile and/or non-volatile storage components, such as optical, magnetic, organic or other memory or disc storage, which can be integrated in whole or in part with processor(s) 1402. In some implementations, the data storage 1404 can be implemented using a single physical device (e.g., one optical, magnetic, organic or other memory or disc storage unit), while in other implementations, the data storage 1404 can be implemented using two or more physical devices, which may communicate electronically (e.g., via wired or wireless communication). Further, in addition to the computer-readable program instructions 1406, the data storage 1404 may include additional data such as diagnostic data, among other possibilities.

The robotic device 1400 may include at least one controller 1408, which may interface with the robotic device 1400. The controller 1408 may serve as a link between portions of the robotic device 1400, such as a link between mechanical components 1414 and/or electrical components 1416. In some instances, the controller 1408 may serve as an interface between the robotic device 1400 and another computing device. Furthermore, the controller 1408 may serve as an interface between the robotic system 1400 and a user(s). The controller 1408 may include various components for communicating with the robotic device 1400, including one or more joysticks or buttons, among other features. The controller 1408 may perform other operations for the robotic device 1400 as well. Other examples of controllers may exist as well.

Additionally, the robotic device 1400 includes one or more sensor(s) 1410 such as force sensors, proximity sensors, motion sensors, load sensors, position sensors, touch sensors, depth sensors, ultrasonic range sensors, and/or infrared sensors, among other possibilities. The sensor(s) 1410 may provide sensor data to the processor(s) 1402 to allow for appropriate interaction of the robotic system 1400 with the environment as well as monitoring of operation of the systems of the robotic device 1400. The sensor data may be used in evaluation of various factors for activation and deactivation of mechanical components 1414 and electrical components 1416 by controller 1408 and/or a computing system of the robotic device 1400.

The sensor(s) 1410 may provide information indicative of the environment of the robotic device for the controller 1408 and/or computing system to use to determine operations for the robotic device 1400. For example, the sensor(s) 1410 may capture data corresponding to the terrain of the environment or location of nearby objects, which may assist with environment recognition and navigation, etc. In an example configuration, the robotic device 1400 may include a sensor system that may include a camera, RADAR, LIDAR, time-of-flight camera, global positioning system (GPS) transceiver, and/or other sensors for capturing information of the environment of the robotic device 1400. The sensor(s) 1410 may monitor the environment in real-time and detect obstacles, elements of the terrain, weather conditions, temperature, and/or other parameters of the environment for the robotic device 1400.

Further, the robotic device 1400 may include other sensor(s) 1410 configured to receive information indicative of the state of the robotic device 1400, including sensor(s) 1410 that may monitor the state of the various components of the robotic device 1400. The sensor(s) 1410 may measure activity of systems of the robotic device 1400 and receive information based on the operation of the various features of the robotic device 1400, such the operation of extendable legs, arms, or other mechanical and/or electrical features of the robotic device 1400. The sensor data provided by the sensors may enable the computing system of the robotic device 1400 to determine errors in operation as well as monitor overall functioning of components of the robotic device 1400.

For example, the computing system may use sensor data to determine the stability of the robotic device 1400 during operations as well as measurements related to power levels, communication activities, components that require repair, among other information. As an example configuration, the robotic device 1400 may include gyroscope(s), accelerometer(s), and/or other possible sensors to provide sensor data relating to the state of operation of the robotic device. Further, sensor(s) 1410 may also monitor the current state of a function that the robotic system 1400 may currently be operating. Additionally, the sensor(s) 1410 may measure a distance between a given robotic limb of a robotic device and a center of mass of the robotic device. Other example uses for the sensor(s) 1410 may exist as well.

Additionally, the robotic device 1400 may also include one or more power source(s) 1412 configured to supply power to various components of the robotic device 1400. Among possible power systems, the robotic device 1400 may include a hydraulic system, electrical system, batteries, and/or other types of power systems. As an example illustration, the robotic device 1400 may include one or more batteries configured to provide power to components via a wired and/or wireless connection. Within examples, components of the mechanical components 1414 and electrical components 1416 may each connect to a different power source or may be powered by the same power source. Components of the robotic system 1400 may connect to multiple power sources as well.

Within example configurations, any type of power source may be used to power the robotic device 1400, such as a gasoline and/or electric engine. Further, the power source(s) 1412 may charge using various types of charging, such as wired connections to an outside power source, wireless charging, combustion, or other examples. Other configurations may also be possible. Additionally, the robotic device 1400 may include a hydraulic system configured to provide power to the mechanical components 1414 using fluid power. Components of the robotic device 1400 may operate based on hydraulic fluid being transmitted throughout the hydraulic system to various hydraulic motors and hydraulic cylinders, for example. The hydraulic system of the robotic device 1400 may transfer a large amount of power through small tubes, flexible hoses, or other links between components of the robotic device 1400. Other power sources may be included within the robotic device 1400.

Mechanical components 1414 can represent hardware of the robotic system 1400 that may enable the robotic device 1400 to operate and perform physical functions. As a few examples, the robotic device 1400 may include actuator(s), extendable leg(s), arm(s), wheel(s), one or multiple structured bodies for housing the computing system or other components, and/or other mechanical components. The mechanical components 1414 may depend on the design of the robotic device 1400 and may also be based on the functions and/or tasks the robotic device 1400 may be configured to perform. As such, depending on the operation and functions of the robotic device 1400, different mechanical components 1414 may be available for the robotic device 1400 to utilize. In some examples, the robotic device 1400 may be configured to add and/or remove mechanical components 1414, which may involve assistance from a user and/or other robotic device.

The electrical components 1416 may include various components capable of processing, transferring, providing electrical charge or electric signals, for example. Among possible examples, the electrical components 1416 may include electrical wires, circuitry, and/or wireless communication transmitters and receivers to enable operations of the robotic device 1400. The electrical components 1416 may interwork with the mechanical components 1414 to enable the robotic device 1400 to perform various operations. The electrical components 1416 may be configured to provide power from the power source(s) 1412 to the various mechanical components 1414, for example. Further, the robotic device 1400 may include electric motors. Other examples of electrical components 1416 may exist as well.

In some implementations, the robotic device 1400 may also include communication link(s) 1418 configured to send and/or receive information. The communication link(s) 1418 may transmit data indicating the state of the various components of the robotic device 1400. For example, information read in by sensor(s) 1410 may be transmitted via the communication link(s) 1418 to a separate device. Other diagnostic information indicating the integrity or health of the power source(s) 1412, mechanical components 1414, electrical components 1416, processor(s) 1402, data storage 1404, and/or controller 1408 may be transmitted via the communication link(s) 1418 to an external communication device.

In some implementations, the robotic device 1400 may receive information at the communication link(s) 1418 that is processed by the processor(s) 1402. The received information may indicate data that is accessible by the processor(s) 1402 during execution of the program instructions 1406, for example. Further, the received information may change aspects of the controller 1408 that may affect the behavior of the mechanical components 1414 or the electrical components 1416. In some cases, the received information indicates a query requesting a particular piece of information (e.g., the operational state of one or more of the components of the robotic device 1400), and the processor(s) 1402 may subsequently transmit that particular piece of information back out the communication link(s) 1418.

In some cases, the communication link(s) 1418 include a wired connection. The robotic device 1400 may include one or more ports to interface the communication link(s) 1418 to an external device. The communication link(s) 1418 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

1. A method comprising:
identifying, using sensor data captured by at least one first sensor, an empty pallet;
determining whether to grasp the empty pallet using an end effector of a mobile robotic device based on at least one characteristic of the empty pallet and at least one capability of the mobile robotic device; and
grasping the empty pallet using the end effector of the mobile robotic device.

2. The method of claim 1, wherein the at least one first sensor includes a sensor coupled to the mobile robotic device, and wherein the at least one first sensor includes at least one of a two-dimensional (2D) camera or a stereoscopic camera.

3-5. (canceled)

6. The method of claim 1, wherein identifying the empty pallet comprises:
determining the at least one characteristic of the empty pallet based on the sensor data; and
identifying the empty pallet based on the at least one characteristic.

7. The method of claim 1, wherein identifying the empty pallet comprises:
detecting, in the sensor data, an identifier tag identifying the empty pallet.

8. The method of claim 1, wherein identifying the empty pallet comprises:
determining the sensor data indicates the mobile robotic device is positioned at a location known to include empty pallets.

9. The method of claim 1, wherein determining whether to grasp the empty pallet using the end effector comprises:
determining a location to place the empty pallet once grasped; and
determining whether to grasp the empty pallet using the end effector based on the location to place the empty pallet.

10. The method of claim 1, wherein grasping the empty pallet using the end effector comprises:
determining a target location to place the empty pallet using the end effector;
based on the target location, determining to grasp the empty pallet at a first grasping location on the empty pallet; and
grasping the empty pallet at the first grasping location.

11. The method of claim 1, wherein determining whether to grasp the empty pallet using the end effector based on the at least one characteristic of the empty pallet comprises:
determining a condition of the empty pallet based on the sensor data; and
determining whether to grasp the empty pallet based on the condition of the empty pallet.

12. The method of claim 1, wherein grasping the empty pallet using the end effector comprises:
determining a condition of the empty pallet based on the sensor data;
based on the condition, determining to grasp the empty pallet at a first grasping location on the empty pallet; and
grasping the empty pallet at the first grasping location.

13. The method of claim 1, wherein determining whether to grasp the empty pallet using the end effector based on the at least one characteristic of the empty pallet comprises:
determining a size of the empty pallet based on the sensor data; and
determining whether to grasp the empty pallet based on the size of the empty pallet.

14. The method of claim 1, wherein grasping the empty pallet using the end effector comprises:
determining a size of the empty pallet based on the sensor data;
based on the size, determining to grasp the empty pallet at a first grasping location on the empty pallet; and
grasping the empty pallet at the first grasping location.

15. The method of claim 1, wherein determining whether to grasp the empty pallet using the end effector based on the at least one characteristic of the empty pallet comprises:
determining a pallet type of the empty pallet based on the sensor data; and
determining whether to grasp the empty pallet based on the pallet type of the empty pallet.

16. The method of claim 1, wherein grasping the empty pallet using the end effector comprises:
determining a pallet type of the empty pallet based on the sensor data;
based on the pallet type, determining to grasp the empty pallet at a first grasping location on the empty pallet; and
grasping the empty pallet at the first grasping location.

17. The method of claim 1, wherein determining whether to grasp the empty pallet using the end effector based on the at least one capability of the mobile robotic device comprises:
determining whether the end effector is configured for grasping empty pallets; and
determining whether to grasp the empty pallet using the end effector based on determining the end effector is configured for grasping empty pallets.

18. The method of claim 1, wherein determining whether to grasp the empty pallet using the end effector based on the at least one characteristic of the empty pallet and the at least one capability of the mobile robotic device comprises:
estimating a size of the empty pallet using the sensor data;
determining whether the end effector is configured for grasping empty pallets of the size; and
determining whether to grasp the empty pallet using the end effector based on determining the end effector is configured for grasping empty pallets of the estimated size.

19. The method of claim 1, wherein determining whether to grasp the empty pallet using the end effector based on the at least one characteristic of the empty pallet and the at least one capability of the mobile robotic device comprises:
estimating a weight of the empty pallet based on the sensor data;
determining whether the end effector is configured for grasping empty pallets having the estimated weight; and
determining whether to grasp the empty pallet using the end effector based on determining the end effector is configured for grasping empty pallets having the estimated weight.

20. The method of claim 1, wherein the end effector comprises a robotic gripper coupled to a robotic arm of the mobile robotic device, the robotic gripper including a plurality of vacuum assemblies, and wherein grasping the empty pallet using the end effector of the mobile robotic device comprises:
activating at least some of the plurality of vacuum assemblies to grasp the empty pallet.

21. The method of claim 1, wherein the end effector comprises a mechanical accessory coupled to a robotic arm of the mobile robotic device, and wherein grasping the empty pallet comprises grasping the empty pallet using the mechanical accessory.

22. (canceled)

23-30. (canceled)

31. A mobile robotic device comprising:
a mobile base;
an end effector; and
a controller configured to:
identify an empty pallet using sensor data received from at least one first sensor;
determine whether to grasp the empty pallet using the end effector based on at least one characteristic of the empty pallet and at least one capability of the mobile robotic device; and
control the end effector to grasp the empty pallet.

32-52. (canceled)

53. A controller for a mobile robotic device, the controller configured to:
identify an empty pallet using sensor data received from at least one first sensor;
determine whether to grasp the empty pallet using an end effector of the mobile robotic device based on at least one characteristic of the empty pallet and at least one capability of the mobile robotic device; and
control the end effector to grasp the empty pallet.

54-113. (canceled)
